(19) United States
(12) Patent Application Publication
(10) Pub. No.: US 2026/0252039 A1
(43) Pub. Date: Aug. 27, 2026

(54) IMPLEMENTING OPERATING PARAMETERS IN INDUSTRIAL PROCESSES

(71) Applicant: AUGURY SYSTEMS LTD., Haifa (IL)

(72) Inventors: Lior AKAVIA, Tel Aviv (IL); Liran AKAVIA, Tel Aviv (IL); Yuval NARDI, Kiryat Anavim (IL); Yehoshua ROSENBERG, Nokdim (IL); Yaron SCHERF, Tel Aviv (IL)

(21) Appl. No.: 18/708,150

(22) PCT Filed: Nov. 8, 2022
(86) PCT No.: PCT/IL2022/051180

§ 371 Date: May 7, 2024

Related U.S. Application Data
(60) Provisional application No. 63/276,930, filed on Nov. 8, 2021.

(51) Int. Cl. G05B 13/02

(52) U.S. Cl. CPC G05B 13/0265

(57) ABSTRACT

A method for implementing an optimal set of operating parameters (SOP) in an industrial process, including providing operational data, the operational data including a multiplicity of historical SOPs, applying an evolutionary algorithm (EA) to the operational data, thereby identifying an optimal SOP, the applying including supplying to the EA a subset of the historical SOPs, employing the subset of the historical SOPs in breeding a multiplicity of candidate SOPs and selecting an optimal SOP from the candidate SOPs, and implementing the optimal SOP in the industrial process, and a system for implementing the method.

### REFERENCE TO RELATED APPLICATIONS

Reference is hereby made to U.S. Provisional Patent Application Ser. No. 63/276,930, filed Nov. 8, 2021 and entitled OPERATING ENVELOPE SUITE, the disclosure of which is hereby incorporated by reference and priority of which is hereby claimed.

### FIELD OF THE INVENTION

The present invention relates to implementing operating parameters in industrial processes, and particularly to identifying the operating parameters using evolutionary algorithms.

### BACKGROUND OF THE INVENTION

Various methods and systems are known for implementing operating parameters in industrial processes, and identifying the operating parameters using evolutionary algorithms.

### SUMMARY OF THE INVENTION

The present invention seeks to provide improved methods and systems for implementing operating parameters in industrial processes, particularly for identifying the operating parameters using evolutionary algorithms.

There is thus provided in accordance with a preferred embodiment of the present invention a method for implementing an optimal set of operating parameters (SOP) in an industrial process, which involves operation of at least one machine, the method including providing operational data, the operational data including a multiplicity of historical SOPs, generating at least one additional SOP from the operational data, applying an evolutionary algorithm (EA) to the operational data, thereby identifying an optimal SOP, the applying including supplying to the EA a subset of the historical SOPs and the at least one additional SOP, employing the subset of the historical SOPs and the at least one additional SOP in breeding a multiplicity of candidate SOPs and selecting an optimal SOP from the candidate SOPs, and implementing the optimal SOP in the industrial process.

In accordance with a preferred embodiment of the present invention, the operational data further includes a multiplicity of historical sets of Key Performance Indicators (KPIs), each of the historical sets of KPIs corresponding to one of the historical SOPs, each of the subset of the historical SOPs includes one of the historical SOPs corresponding to a particularly desirable one of the historical sets of KPIs.

Preferably, the operational data further includes a multiplicity of historical sets of KPIs and the at least one additional SOP includes a plurality of types of operating parameters and plurality of additional operating parameter value ranges (OPVRs), each of the plurality of additional OPVRs corresponding to a particularly desirable one of the historical sets of KPIs.

There is also provided in accordance with another preferred embodiment of the present invention a method for implementing an SOP in an industrial process, which involves operation of at least one machine, the method including providing operational data, the operational data including historical SOPs, each of the historical SOPs including a plurality of types of operating parameters, and a plurality of historical OPVRs, each of the historical OPVRs corresponding to one of the types of operating parameters, and each of the historical OPVRs having a historical minimum parameter value and a historical maximum parameter value, which are separated by a historical OPVR spread, applying an EA to the operational data, thereby identifying an optimal SOP, the applying including employing at least some of the operational data in breeding a multiplicity of candidate SOPs, each of the candidate SOPs including the plurality of types of operating parameters, and a plurality of candidate OPVRs, each of the candidate OPVRs corresponding to one of the types of operating parameters, and each of the candidate OPVRs having a candidate minimum parameter value and a candidate maximum parameter value, which are separated by a candidate OPVR spread, and selecting an optimal SOP from the candidate SOPs, and implementing the optimal SOP in the industrial process.

In accordance with a preferred embodiment of the present invention, each of the candidate OPVR spreads includes an average of at least some of the historical OPVR spreads. Preferably, the average is a weighted average, and each of the historical SOPs is characterized by a weighting coefficient. Preferably, the weighting coefficient indicates a recency of the historical SOP.

In accordance with a preferred embodiment of the present invention, the operational data further includes a multiplicity of historical sets of KPIs, each of the sets of KPIs being associated with one of the historical SOPs, and the weighting coefficient indicates a desirability of the historical set of KPIs.

There is further provided in accordance with yet another preferred embodiment of the present invention a method for implementing an optimal SOP in an industrial process, which involves operation of at least one machine, the method including providing operational data, applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a Mann-Whitney Stochastic Order analysis, and selecting an optimal SOP from the desirable candidate SOPs, and implementing the optimal SOP in the industrial process.

There is further provided in accordance with yet another preferred embodiment of the present invention a method for implementing an optimal SOP in an industrial process, which involves operation of at least one machine, the method including providing operational data spanning a time range, the operational data including a plurality of historical SOPs, each relating to an SOP-time interval, the SOP-time intervals, when added together, being substantially equal to the time range, and a multiplicity of historical sets of Key Performance Indicators (KPIs), each of the historical sets of KPIs corresponding to one of the historical SOPs, and applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a period dominancy analysis, and selecting an optimal SOP from the desirable candidate SOPs, and implementing the optimal SOP in the industrial process.

In a preferred embodiment of the present invention, each of the candidate SOPs is associated with a corresponding candidate set of candidate KPIs and for each of the candidate SOPs, the period dominancy analysis includes evaluating, for each of the SOP-time intervals in the time range, whether or not the candidate set of KPIs associated with the candidate SOP is more desirable than the historical set of KPI corresponding to the SOP-time interval. Preferably, each of the SOP-time intervals has a value indicating a unit of time particularly relevant to the industrial process.

There is further provided in accordance with yet another preferred embodiment of the present invention a method for implementing an optimal SOP in an industrial process, which involves operation of at least one machine, the method including providing operational data, applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a recency weighting, and selecting an optimal SOP from the desirable candidate SOPs, and implementing the optimal SOP in the industrial process.

Preferably, the cost function evaluates a desirability of the candidate SOPs relative to a desirability of the historical SOPs and assigns a higher importance to a desirability of the candidate SOPs relative to more recent ones of the historical SOPs, and a lower importance to a desirability of the candidate SOPs relative to less recent ones of the historical SOPs.

There is further provided in accordance with yet another preferred embodiment of the present invention a method for implementing an optimal SOP in an industrial process, which involves operation of at least one machine, the method including providing operational data, applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including one or more of a Mann-Whitney Stochastic Order analysis, a period dominancy analysis and a recency weighting, and selecting an optimal SOP from the desirable candidate SOPs, and implementing the optimal SOP in the industrial process.

There is further provided in accordance with yet another preferred embodiment of the present invention a method for implementing an optimal SOP in an industrial process, which involves operation of at least one machine, the method including providing operational data, applying an EA to the operational data, thereby identifying an optimal SOP, the applying including employing at least some of the operational data in breeding a multiplicity of candidate SOPs and selecting an optimal SOP from the candidate SOPs, and providing a set of KPI weighting ranges for which the optimal SOP is particularly suitable, ascertaining that the set of KPI weighting ranges is desirable for the industrial process and implementing the optimal SOP in the industrial process.

Preferably, the method also includes selecting at least one additional optimal SOP from the candidate SOPs and providing, for each of the at least one additional optimal SOP, an additional set of KPI weighting ranges for which the additional optimal SOP is particularly suitable, ascertaining that the additional set of KPI weighting ranges is desirable for the industrial process and implementing the at least one additional optimal SOP in the industrial process.

There is further provided in accordance with yet another preferred embodiment of the present invention a method for implementing an optimal SOP in an industrial process, which involves operation of at least one machine, the method including providing operational data, applying an EA to the operational data, thereby identifying an optimal SOP, the applying including employing at least some of the operational data in breeding a multiplicity of candidate SOPs and selecting an optimal SOP from candidate SOPs, the optimal SOP including a plurality of types of operating parameters and a plurality of OPVRs, each of the OPVRs corresponding to one of the types of operating parameters, and each of the OPVRs having a minimum parameter value and a maximum parameter value, which are separated by an OPVR spread, providing an optimal operating parameter value for at least one of the OPVRs and employing the optimal operating parameter value in implementing the optimal SOP in the industrial process.

In accordance with a preferred embodiment of the present invention, the providing the optimal operating parameter value for at least one of the OPVRs includes providing the optimal operating parameter value for each of the OPVRs. Preferably, at least one of the operating parameter values is particularly easy to maintain in the industrial process.

There is further provided in accordance with yet another preferred embodiment of the present invention a method for implementing an optimal SOP in an industrial process, which involves operation of at least one machine, the method including providing operational data, the operational data including a multiplicity of historical SOPs, each of the historical SOPs including a multiplicity of types of operating parameters, and a plurality of historical single-SOP OPVRs, each of the historical single-SOP OPVRs corresponding to one of the types of operating parameters, and at least one historical combined SOP, the historical combined SOP including the multiplicity of types of operating parameters, and a plurality of historical multiple-SOP OPVRs, each of the historical multiple-SOP OPVRs corresponding the multiple ones of the historical single-SOP OPVRs, applying at least one EA to the operational data, thereby identifying an optimal SOP, the optimal SOP including the multiplicity of types of operating parameters and a plurality of optimal OPVRs, each of the optimal OPVRs corresponding to one of the types of operating parameters and lying entirely within a corresponding one of the historical multiple-SOP OPVRs, providing at least one partially-optimal SOP, each of the at least one partially-optimal SOPs including the multiplicity of types of operating parameters and a plurality of partially-optimal OPVRs, each of the partially-optimal OPVRs corresponding to one of the types of operating parameters and lying entirely within a corresponding one of the historical multiple-SOP OPVRs and at least partially overlapping a corresponding one of the optimal OPVRs, and implementing the at least one partially-optimal SOP in the industrial process.

Preferably, the method also includes providing an optimal partially-optimal operating parameter value for at least one of the partially-optimal OPVRs and employing the optimal partially-optimal operating parameter value in implementing the partially-optimal SOP in the industrial process.

In accordance with a preferred embodiment of the present invention, the providing the optimal partially-optimal operating parameter value for at least one of the partially-optimal OPVRs includes providing the optimal partially-optimal operating parameter value for each of the partially-optimal OPVRs.

In accordance with a preferred embodiment of the present invention, the method further includes implementing the optimal SOP in the industrial process.

Preferably, the partially-optimal OPVRs include a first sub-set of partially-optimal OPVRs, corresponding to a first sub-set of the multiplicity of types of operating parameters, the first sub-set of partially-optimal OPVRs being substantially identical with a corresponding sub-set of the optimal OPVRs, and a second sub-set of partially-optimal OPVRs, corresponding to a second sub-set of the multiplicity of types of operating parameters, the second sub-set of partially-optimal OPVRs being substantially identical with a corresponding sub-set of the historical multiple-SOP OPVRs.

Preferably, each of the historical multiple-SOP OPVRs has a historical multiple-SOP minimum parameter value and a historical multiple-SOP maximum parameter value, which are separated by a historical multiple-SOP OPVR spread, each of the optimal OPVRs has a minimum optimal parameter value and a maximum optimal parameter value, which are separated by an optimal OPVR spread, and each of the partially-optimal OPVRs has a minimum partially-optimal parameter value and a maximum partially-optimal parameter value, which are separated by a partially-optimal OPVR spread, the partially-optimal OPVR spread being smaller than a corresponding one of the historical multiple-SOP OPVR spreads and larger than a corresponding one of the optimal OPVR spreads.

In accordance with a preferred embodiment of the present invention, the at least one partially-optimal SOP is identified by applying a non-evolutionary algorithm to the optimal SOP. Alternatively, in accordance with a preferred embodiment of the present invention, the at least one partially-optimal SOP is identified by applying at least one EA to the operational data.

There is further provided in accordance with yet another preferred embodiment of the present invention a system for implementing an optimal SOP in an industrial process, which involves operation of at least one machine, the system including an operational data database and selector for providing operational data, the operational data including a multiplicity of historical SOPs, an SOP generator for generating at least one additional SOP from the operational data, an EA engine for applying an EA to the operational data, thereby identifying an optimal SOP, the EA engine operative to receive a subset of the historical SOPs and the at least one additional SOP, employ the subset of the historical SOPs and the at least one additional SOP in breeding a multiplicity of candidate SOPs and select an optimal SOP from the candidate SOPs, and an SOP implementor for implementing the optimal SOP in the industrial process.

In accordance with a preferred embodiment of the present invention, the operational data provided by the operational data database and selector includes a multiplicity of historical sets of KPIs, each of the historical sets of KPIs corresponding to one of the historical SOPs, and each of the subset of the historical SOPs to which the EA is applied includes one of the historical SOPs corresponding to a particularly desirable one of the historical sets of KPIs.

Preferably, the operational data provided by the operational data database and selector further includes a multiplicity of historical sets of KPIs and the at least one additional SOP generated by the SOP generator includes a plurality of types of operating parameters and a plurality of additional OPVRs, each of the plurality of additional OPVRs corresponding to a particularly desirable one of the historical sets of KPIs.

There is further provided in accordance with yet another preferred embodiment of the present invention a system for implementing an optimal SOP in an industrial process, which involves operation of at least one machine, the system including an operational data database and selector for providing operational data, the operational data including historical SOPs, each of the historical SOPs including a plurality of types of operating parameters and a plurality of historical OPVRs, each of the historical OPVRs corresponding to one of the types of operating parameters, and each of the historical OPVRs having a historical minimum parameter value and a historical maximum parameter value, which are separated by a historical OPVR spread, an EA engine for applying an EA to the operational data, thereby identifying an optimal SOP, the applying including employing at least some of the operational data in breeding a multiplicity of candidate SOPs, each of the candidate SOPs including the plurality of types of operating parameters and a plurality of candidate OPVRs, each of the candidate OPVRs corresponding to one of the types of operating parameters, and each of the candidate OPVRs having a candidate minimum parameter value and a candidate maximum parameter value, which are separated by a candidate OPVR spread, selecting an optimal SOP from the candidate SOPs, and an SOP implementor for implementing the optimal SOP in the industrial process.

In accordance with a preferred embodiment of the present invention, each of the candidate OPVR spreads includes an average of at least some of the historical OPVR spreads. Preferably, the average is a weighted average, and each of the historical SOPs is characterized by a weighting coefficient. Preferably, the weighting coefficient indicates a recency of the historical SOP.

In accordance with a preferred embodiment of the present invention, the operational data further includes a multiplicity of historical sets of KPIs, each of the sets of KPIs being associated with one of the historical SOPs, and the weighting coefficient indicates a desirability of the historical set of KPIs.

There is further provided in accordance with yet another preferred embodiment of the present invention a system for implementing an optimal SOP in an industrial process, which involves operation of at least one machine, the system including an operational data database and selector for providing operational data, an EA engine for applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a Mann-Whitney Stochastic Order analysis, and selecting an optimal SOP from the desirable candidate SOPs, and an SOP implementor for implementing the optimal SOP in the industrial process.

There is further provided in accordance with yet another preferred embodiment of the present invention a system for implementing an optimal SOP in an industrial process, which involves operation of at least one machine, the system including an operational data database and selector for providing operational data spanning a time range, the operational data including a plurality of historical SOPs, each relating to an SOP-time interval, the SOP-time intervals, when added together, being substantially equal to the time range, and a multiplicity of historical sets of KPIs, each of the historical sets of KPIs corresponding to one of the historical SOPs, and an EA engine for applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a period dominancy analysis, and selecting an optimal SOP from the desirable candidate SOPs and an SOP implementor for implementing the optimal SOP in the industrial process.

Preferably, each of the candidate SOPs is associated with a corresponding candidate set of candidate KPIs and for each of the candidate SOPs, the period dominancy analysis includes evaluating, for each of the SOP-time intervals in the time range, whether or not the candidate set of KPIs associated with the candidate SOP is more desirable than the historical set of KPI corresponding to the SOP-time interval.

In accordance with a preferred embodiment of the present invention, each of the SOP-time intervals has a value indicating a unit of time particularly relevant to the industrial process.

There is further provided in accordance with yet another preferred embodiment of the present invention a system for implementing an optimal SOP in an industrial process, which involves operation of at least one machine, the system including an operational data database and selector for providing operational data, an EA engine for applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including a recency weighting, and selecting an optimal SOP from the desirable candidate SOPs, and an SOP implementor for implementing the optimal SOP in the industrial process.

In accordance with a preferred embodiment of the present invention, the cost function evaluates a desirability of the candidate SOPs relative to a desirability of the historical SOPs and assigns a higher importance to a desirability of the candidate SOPs relative to more recent ones of the historical SOPs, and a lower importance to a desirability of the candidate SOPs relative to less recent ones of the historical SOPs.

There is further provided in accordance with yet another preferred embodiment of the present invention a system for implementing an optimal SOP in an industrial process, which involves operation of at least one machine, the system including an operational data database and selector for providing operational data, an EA engine for applying an EA to the operational data, thereby identifying an optimal SOP, the applying including employing at least some of the operational data in breeding a multiplicity of candidate SOPs, applying a cost function to the candidate SOPs, thereby identifying a multiplicity of desirable candidate SOPs, the cost function including one or more of a Mann-Whitney Stochastic Order analysis, a period dominancy analysis and a recency weighting, and selecting an optimal SOP from the desirable candidate SOPs, and an SOP implementor for implementing the optimal SOP in the industrial process.

There is further provided in accordance with yet another preferred embodiment of the present invention a system for implementing an optimal SOP in an industrial process, which involves operation of at least one machine, the system including an operational data database and selector for providing operational data, an EA engine for applying an EA to the operational data, thereby identifying an optimal SOP, the applying including employing at least some of the operational data in breeding a multiplicity of candidate SOPs, selecting an optimal SOP from the candidate SOPs and providing a set of KPI weighting ranges for which the optimal SOP is particularly suitable, and an SOP implementor for implementing the optimal SOP in the industrial process.

There is further provided in accordance with yet another preferred embodiment of the present invention a system for implementing an optimal SOP in an industrial process, which involves operation of at least one machine, the system including an operational data database and selector for providing operational data, an EA engine for applying an EA to the operational data, thereby identifying an optimal SOP, the applying including employing at least some of the operational data in breeding a multiplicity of candidate SOPs and selecting an optimal SOP from candidate SOPs, the optimal SOP including a plurality of types of operating parameters and a plurality of OPVRs, each of the OPVRs corresponding to one of the types of operating parameters, and each of the OPVRs having a minimum parameter value and a maximum parameter value, which are separated by an OPVR spread, a value-selecting engine for providing an optimal operating parameter value for at least one of the OPVRs and an SOP implementor for implementing the optimal SOP in the industrial process, the SOP implementor employing the optimal operating parameter in the implementing the optimal SOP.

In accordance with a preferred embodiment of the present invention, the providing the optimal operating parameter value for at least one of the OPVRs includes providing the optimal operating parameter value for each of the OPVRs. Preferably, at least one of the operating parameter values is particularly easy to maintain in the industrial process.

There is further provided in accordance with yet another preferred embodiment of the present invention a system for implementing an optimal SOP in an industrial process, which involves operation of at least one machine, the system including an operational data database and selector for providing operational data, the operational data including a multiplicity of historical SOPs, each of the historical SOPs including a multiplicity of types of operating parameters, and a plurality of historical single-SOP OPVRs, each of the historical single-SOP OPVRs corresponding to one of the types of operating parameters, and at least one historical combined SOP, the historical combined SOP including the multiplicity of types of operating parameters and a plurality of historical multiple-SOP OPVRs, each of the historical multiple-SOP OPVRs corresponding the multiple ones of the historical single-SOP OPVRs, an optimal evolutionary algorithm EA engine for applying at least one EA to the operational data, thereby identifying an optimal SOP, the optimal SOP including the multiplicity of types of operating parameters and a plurality of optimal OPVRs, each of the optimal OPVRs corresponding to one of the types of operating parameters and lying entirely within a corresponding one of the historical multiple-SOP OPVRs, an additional algorithm engine for providing at least one partially-optimal SOP, each of the at least one partially-optimal SOPs including the multiplicity of types of operating parameters, and a plurality of partially-optimal OPVRs, each of the partially-optimal OPVRs corresponding to one of the types of operating parameters and lying entirely within a corresponding one of the historical multiple-SOP OPVRs and at least partially overlapping a corresponding one of the optimal OPVRs, and an SOP implementor for implementing the at least one partially-optimal SOP in the industrial process.

Preferably, the system further includes a value-selecting engine for providing an optimal partially-optimal operating parameter value for at least one of the partially-optimal OPVRs and the OP implementor employs the optimal partially-optimal operating parameter value in implementing the partially-optimal SOP in the industrial process.

In accordance with a preferred embodiment of the present invention, the providing the optimal partially-optimal operating parameter value for at least one of the partially-optimal OPVRs includes providing the optimal partially-optimal operating parameter value for each of the partially-optimal OPVRs.

Preferably, the partially-optimal OPVRs include a first sub-set of partially-optimal OPVRs, corresponding to a first sub-set of the multiplicity of types of operating parameters, the first sub-set of partially-optimal OPVRs being substantially identical with a corresponding sub-set of the optimal OPVRs, and a second sub-set of partially-optimal OPVRs, corresponding to a second sub-set of the multiplicity of types of operating parameters, the second sub-set of partially-optimal OPVRs being substantially identical with a corresponding sub-set of the historical multiple-SOP OPVRs.

Preferably, each of the historical multiple-SOP OPVRs has a historical multiple-SOP minimum parameter value and a historical multiple-SOP maximum parameter value, which are separated by a historical multiple-SOP OPVR spread, each of the optimal OPVRs has a minimum optimal parameter value and a maximum optimal parameter value, which are separated by an optimal OPVR spread, and each of the partially-optimal OPVRs has a minimum partially-optimal parameter value and a maximum partially-optimal parameter value, which are separated by a partially-optimal OPVR spread, the partially-optimal OPVR spread being smaller than a corresponding one of the historical multiple-SOP OPVR spreads and larger than a corresponding one of the optimal OPVR spreads.

In accordance with a preferred embodiment of the present invention, the additional algorithm engine is an additional non-EA engine for applying a non-evolutionary algorithm to the optimal SOP. Alternatively, in accordance with a preferred embodiment of the present invention, the additional algorithm engine is an additional EA engine for applying at least one EA to the operational data.

### BRIEF DESCRIPTION OF THE DRAWINGS

The present invention will be understood and appreciated more fully from the following detailed description, taken in conjunction with the drawings in which:

FIG. 1A is a simplified flowchart illustrating a method for implementing an optimal set of operating parameters (SOP) in an industrial process, which involves operation of at least one machine, in accordance with a preferred embodiment of the present invention;

FIG. 1B is a simplified representation of exemplary data used in selected steps of the method of FIG. 1A;

FIG. 1C is a simplified plot illustrating exemplary data used in selected steps of the method of FIG. 1A;

FIG. 1D is a simplified plot illustrating additional exemplary data used in selected steps of the method of FIG. 1A;

FIG. 1E is a simplified plot illustrating yet additional exemplary data used in selected steps of the method of FIG. 1A;

FIG. 1F is a simplified flowchart illustrating a portion of the method of FIG. 1A;

FIG. 2 is a simplified schematic illustration of a system for implementing an optimal set of operating parameters (SOP) in an industrial process, which involves operation of at least one machine, useful in performing the methods of FIG. 1A, in accordance with a preferred embodiment of the present invention;

FIG. 3A is a simplified flowchart illustrating a method for implementing an optimal SOP in an industrial process, which involves operation of at least one machine, in accordance with another preferred embodiment of the present invention;

FIG. 3B is a simplified representation of exemplary data used in selected steps of the method of FIG. 3A;

FIG. 3C is a simplified plot illustrating exemplary data used in selected steps of the method of FIG. 3A;

FIG. 3D is a simplified plot illustrating additional exemplary data used in selected steps of the method of FIG. 3A;

FIG. 3E is a simplified plot illustrating yet additional exemplary data used in selected steps of the method of FIG. 3A;

FIG. 3F is a simplified flowchart illustrating a portion of the method of FIG. 3A; and

FIG. 4 is a simplified schematic illustration of a system for implementing an optimal set of operating parameters (SOP) in an industrial process, which involves operation of at least one machine, useful in performing the methods of FIG. 3A, in accordance with a preferred embodiment of the present invention.

### DETAILED DESCRIPTION OF PREFERRED EMBODIMENTS

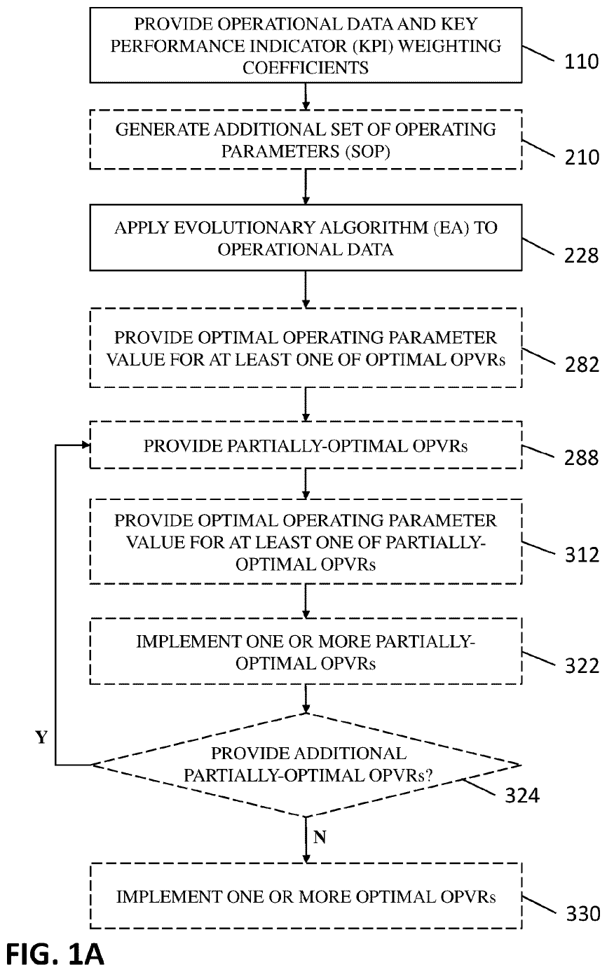

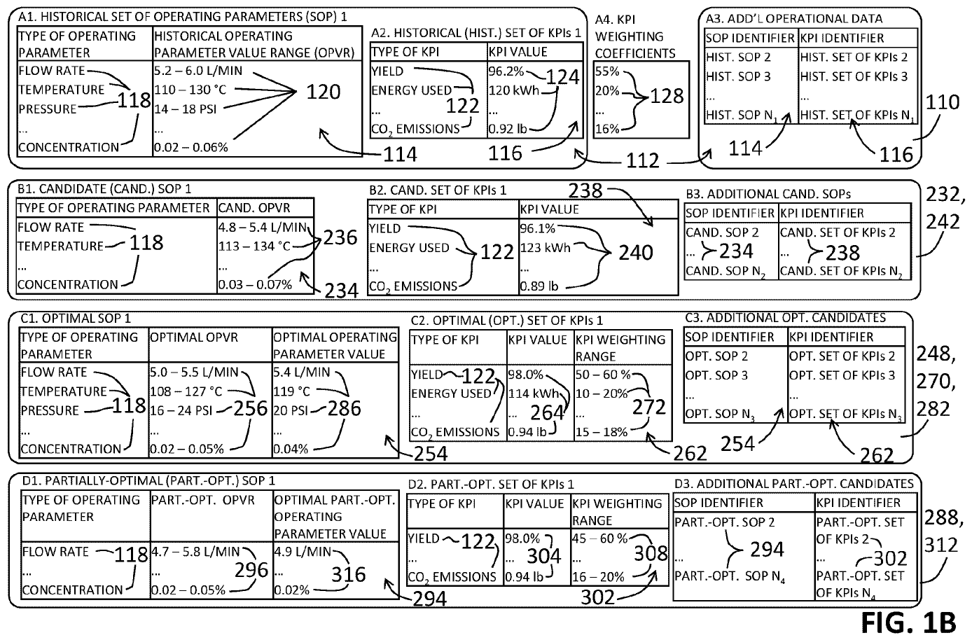

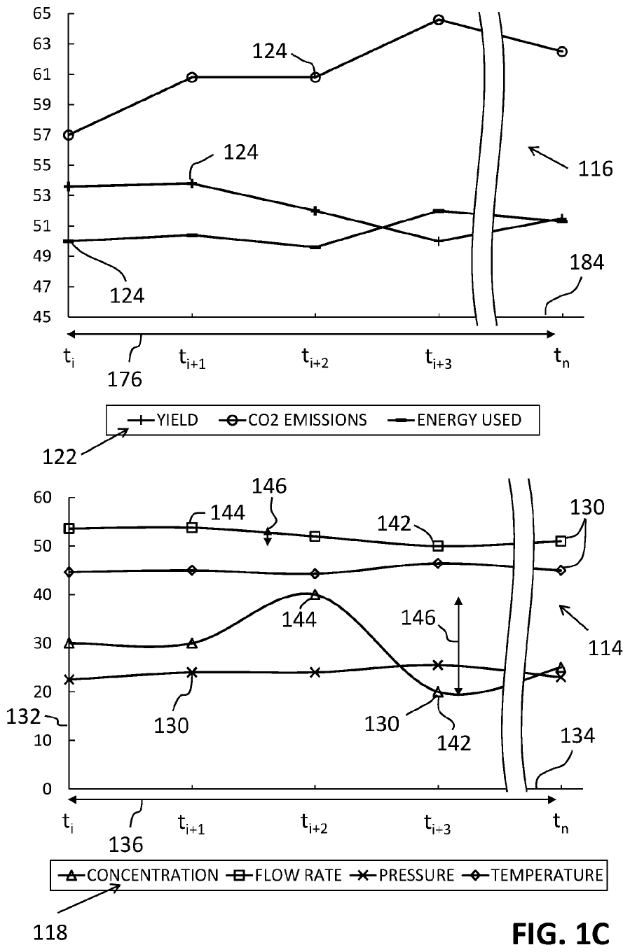

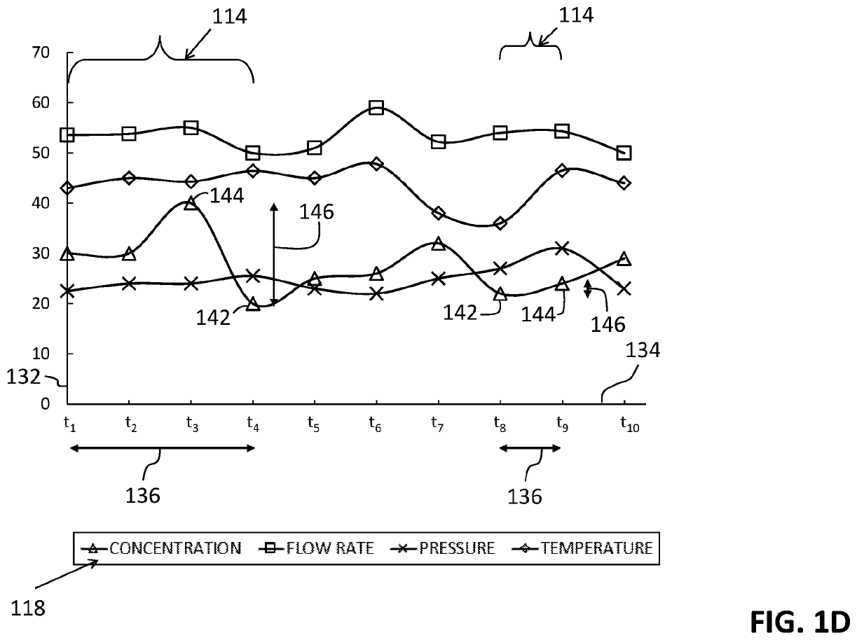

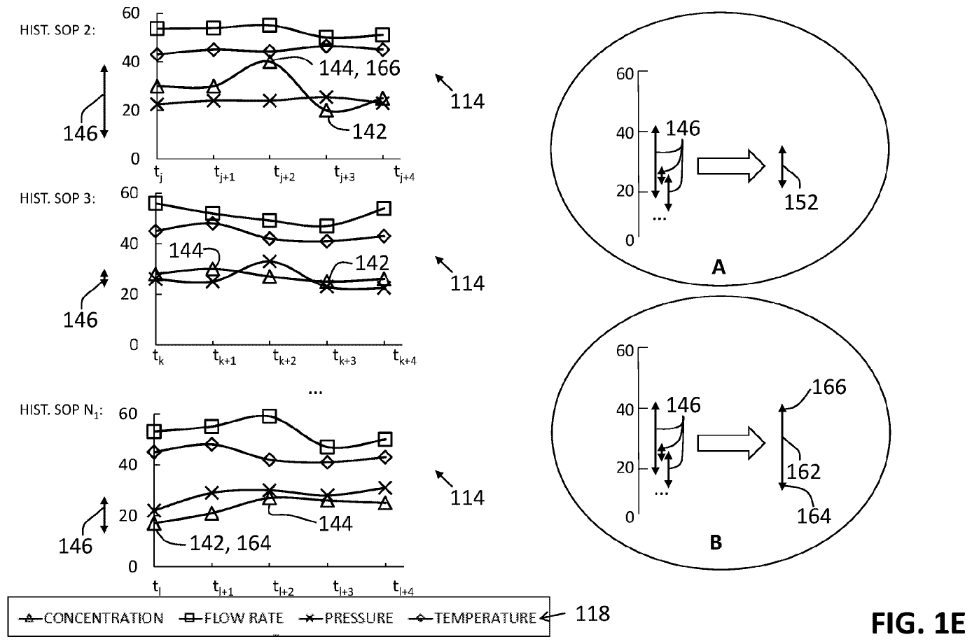

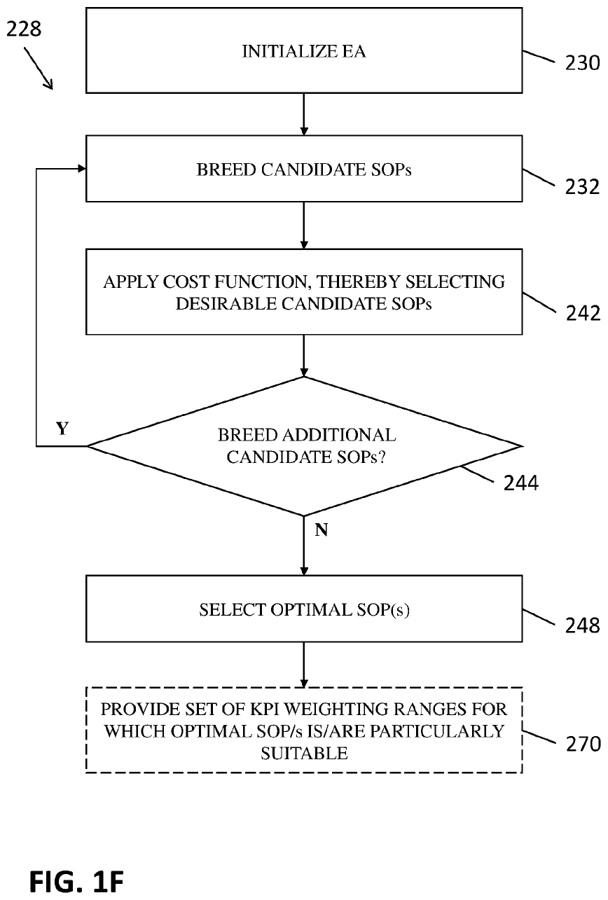

It is appreciated that the system and method described hereinbelow with reference to FIGS. 1A-4 form part of an industrial process involving an operation of at least one machine, including either a single machine, such as a motor or transformer, or multiple machines, such as a mining process or a manufacturing process, and the outputs provided by the system and method described hereinbelow with reference to FIGS. 1A-4 are used to improve the industrial process, for example to increase efficiency of the industrial process or to reduce monetary or other costs associated with the industrial process.

As is known in the art, industrial processes are typically associated with both sets of operating parameters (SOPs) and corresponding sets of Key Process Indicators (KPIs). Exemplary operating parameters in the SOPs include, inter alia, flow rates, pressures, temperatures, grades of raw materials, pH, relative concentrations of raw materials, stirring rates, rotation angles, rotation rates, linear displacements, belt speeds, process times, duty cycles, compression ratios, vibration levels and measured temperatures. Exemplary KPIs in the sets of KPIs include, inter alia, monetary costs, throughput, yield, emissions, efficiency, such as overall operating efficiency, repair costs, waste, overall equipment effectiveness including machine downtime, capacity utilization, on-time project delivery, inventory accuracy, raw material usage, total cycle time, noise levels, machine health, man-hours and product quality.

A single industrial process typically uses multiple SOPs, each of which is associated with a corresponding set of KPIs. Over time, these multiple SOPs and their associated sets of KPIs are accumulated and stored as historical operational data. To ensure that the current operation of the industrial process is characterized by a particularly desirable set of KPIs, it is advantageous for the industrial process to employ an SOP which, in the past, has been associated with a most desirable set of KPIs. Therefore, it is advantageous to search historical data associated with the industrial process, to identify one or more SOPs which are associated with corresponding particularly desirable sets of KPIs. Furthermore, it is advantageous to search for and identify particularly meaningful SOPs, and not those SOPs which may appear to be associated with corresponding particularly desirable sets of KPIs, but in fact represent poor data, such as noise or artifacts.

It is appreciated that as used herein, desirable sets of KPIs are those sets of KPIs identified as relating to particularly advantageous outcomes of the industrial process. For example, a desirable set of KPIs may have relatively high values of efficiency and yield, while having relatively low values of cost and emitted pollutants. Conversely, undesirable sets of KPIs are those sets of KPIs identified as relating to particularly disadvantageous outcomes of the industrial process. For example, an undesirable set of KPIs may have relatively low values of efficiency and yield, while having relatively high values of cost and emitted pollutants.

By way of a further example, KPIs used in the present invention may include KPIs linked to machine health, e.g., KPIs indicating a number or severity of machine breakdowns and/or a machine lifetime. The present invention is preferably useful in identifying and selecting SOPs that are associated with desirable KPIs, i.e., KPIs that are likely to improve machine health. For example, the selected SOPs may be associated with relatively few or non-severe machine breakdowns and/or relatively extended machine lifetimes.

However, searching and identifying the single SOP leading to particularly desirable sets of KPIs within historical data is far from a trivial task. The operating parameters governing an industrial process are highly interdependent and a single industrial process with its associated KPIs may rely on many operating parameters simultaneously, and the operating parameters may have complex interactions with one another. Several partial solutions to this problem have been identified in the prior art, particularly useful of which are evolutionary algorithms (EAs), such as genetic algorithms (GAs).

Nevertheless, identifying optimal SOPs from historical operational data remains a difficult multi-dimensional problem, and it is desirable to reduce computing power and time required to run such searches, as well as increase reliability of results returned by such searches. In addition, plant managers and other human operators are often hesitant to make large changes in current operating setups based on suggestions from artificial intelligence programs, particularly for large-scale, expensive, and often potentially dangerous, industrial processes.

Therefore, the present invention proposes novel and inventive methods and systems, with the object of providing improved industrial processes, by performing searches for optimal SOPs in a manner that is more effective and faster than what is known in the prior art, and also returning partially-optimal SOPs. The present invention preferably provides an ease of use and delivers helpful information to plant operators, enabling industrial processes to be run based on timely and informed decisions.

SOPs, also called operating envelopes, are two or more process inputs or process outputs related to an operation of the industrial process. SOPs are useful in controlling one or more pieces of equipment, such as machines, or one or more machine components, with each of the operating parameters having a quantitative value.

The process inputs of the SOPs preferably relate to factors that affect the industrial process, such as, inter alia, equipment settings such as flow rates, pressures, temperature setpoints, stirring rates and linear speed settings. Additionally, the process inputs of the SOPs preferably relate to factors that affect the industrial process, such as, inter alia, environmental factors of an industrial plant and quality of material used in the industrial process. It is appreciated that the process inputs of the SOP may be readily changeable by an operator, but need not be.

The process outputs of the SOPs preferably relate to factors that result from the industrial process, such as, inter alia, a vibration level of a machine or a measured temperature of a manufactured component.

Reference is now made to FIG. 1A, which is a simplified flow chart illustrating a method for implementing an optimal SOP in an industrial process involving operation of at least one machine, in accordance with a preferred embodiment of the present invention, FIG. 1B, which is a simplified representation of exemplary data used in selected steps of the method of FIG. 1A, FIG. 1C, which is a simplified plot illustrating exemplary data used in selected steps of the method of FIG. 1A, FIG. 1D, which is a simplified plot illustrating additional exemplary data used in selected steps of the method of FIG. 1A, FIG. 1E, which is a simplified plot illustrating yet additional exemplary data used in selected steps of the method of FIG. 1A, and FIG. 1F, which is a simplified flowchart illustrating a portion of the method of FIG. 1A. In FIGS. 1A and 1F, steps outlined in dashed lines are optional. If any optional steps are not performed, the method preferably continues to the next step. It is appreciated that any or all of the optional steps may be in included in the method. Conversely, the method may be performed without including any or all of the optional steps.

As seen in FIGS. 1A & 1B, at a first step 110, a collection of operational data 112 is provided. As seen particularly in FIGS. 1B & 1C, operational data 112 preferably includes a multiplicity of historical SOPs 114, and a multiplicity of historical sets of Key Performance Indicators (KPIs) 116, each of the historical sets of KPIs 116 corresponding to one of the historical SOPs 114.

Historical SOPs 114 relate to operating parameters that have been used in previous runs of by the industrial process, prior to step 110 of the method of FIG. 1A. It is appreciated that operational data 112 can span any suitable time range, the time range being either contiguous or non-contiguous.

For example, the time range spanned by operational data 112 may be, inter alia, an entirety of a previous decade, an entirety of a previous year, an entirety of a previous financial quarter, an entirety of a previous month, or an entirety of a previous week.

Similarly, the time range spanned by operational data 112 may be, inter alia, a previous decade excluding downtime of the industrial process, a previous year excluding downtime of the industrial process, a previous financial quarter excluding downtime of the industrial process, a previous month excluding downtime of the industrial process, or a previous week excluding downtime of the industrial process.

Additionally, the time range spanned by operational data 112 may be, inter alia, a previous decade excluding time periods associated with unusually undesirable KPIs 116, a previous year excluding time periods associated with unusually undesirable KPIs 116, a previous financial quarter excluding time periods associated with unusually undesirable KPIs 116, a previous month excluding time periods associated with unusually undesirable KPIs 116, or a previous week excluding time periods associated with unusually undesirable KPIs 116.

Furthermore, the time range spanned by operational data 112 may be, inter alia, a previous decade including only time spent on a particular process and excluding time spent on other processes, a previous year including only time spent on a particular process and excluding time spent on other processes, a previous financial quarter including only time spent on a particular process and excluding time spent on other processes, a previous month including only time spent on a particular process and excluding time spent on other processes, or a previous week including only time spent on a particular process and excluding time spent on other processes.

Each of historical SOPs 114 typically includes a plurality of types of operating parameters 118 and a plurality of historical operating parameter value ranges (OPVRs) 120, which together describe at least some aspects of the industrial process. As seen particularly in Table A1 of FIG. 1B, each of historical OPVRs 120 corresponds to one of the types of operating parameters 118. In a preferred embodiment of the present invention, each of historical SOPs 114 includes an identical plurality of types of operating parameters 118. In another embodiment of the present invention, some of plurality of types of operating parameters 118 present in some of historical SOPs 114 may be omitted, or may be present without having any corresponding OPVRs 120, in others of historical SOPs 114.

For example, as seen in Table A1 of FIG. 1B, one of historical SOPs 114, Historical SOP 1, includes, inter alia, types of operating parameter 118 of flow rate, temperature, pressure and concentration, having corresponding historical OPVRs 120 of 5.2-6.0 L/min, 110-130° C., 14-18 PSI and 0.02-0.06 w/w %, respectively. It is appreciated that each of types of operating parameters 118 includes more detail than is described herein, for example, a machine or portion of machine with which the type of operating parameter 118 is associated and/or a material type with which the type of operating parameter 118 is associated. Additionally, each historical SOP 114 typically includes many types of operating parameters 118, such as more than 3 types of operating parameters, more than 5 types of operating parameters, more than 10 types of operating parameters, more than 20 types of operating parameters, more than 30 types of operating parameters, more than 50 types of operating parameters, more than 100 types of operating parameters, more than 200 types of operating parameters and more than 500 types of operating parameters. Furthermore, in some embodiments of the present invention, some of types of operating parameters 118 have a unit of measurement which is the same as a unit of measurement as at least one other of types of operating parameters 118. Additionally or alternatively, some types of operating parameters 118 may indicate environmental attributes associated with the industrial process, a type of product being produced or used by the industrial process, machines used by the industrial process, or the like.

For example, a historical SOP 114 for a plant floor employing multiple belt furnaces may include types of operation parameters such as, inter alia, a first furnace identifier, a second furnace identifier, a first furnace first zone temperature, a first furnace second zone temperature, a first furnace third zone temperature, a second furnace first zone temperature, a second furnace second zone temperature, a second furnace third zone temperature, a first furnace linear belt speed, a second furnace linear belt speed, a first furnace first zone vibration frequency, a first furnace second zone vibration frequency, a second furnace first zone vibration frequency, a second furnace second zone vibration frequency, a cooling region temperature, a first furnace nitrogen flow rate, a second furnace nitrogen flow rate, a first furnace CO₂ flow rate, a second furnace CO₂ flow rate, a nitrogen purity grade, a cooling region nitrogen flow rate, a cooling region ambient air flow rate, a first fan rotational rate, a second fan rotational rate, a third fan rotational rate, a fourth fan rotational rate, a fifth fan rotational rate, at least one plant floor ambient humidity percentage, and a plant floor concentration of particles in air.

In a preferred embodiment of the present invention, some historical OPVRs 120 are provided by measured values output by sensors (e.g., an oven temperature measured by a thermocouple). It is appreciated that historical OPVRs 120 may be raw sensor output or data extracted from sensor output, such as, inter alia, an average or standard deviation of raw sensor output, or ratios between outputs of different sensors. Additionally or alternatively, some historical OPVRs 120 are provided by records of actionable values set by users (e.g., a target oven temperature set by an operator).

As described hereinabove and as seen particularly in step 110 of FIG. 1B, each historical SOP 114 is associated with a corresponding one of historical sets of KPIs 116. Each historical set of KPIs 116 typically includes plurality of types of KPIs 122 and a plurality of historical KPI values 124, which together quantify a desirability of the historical SOP 114 with which the historical set of KPIs 116 is associated. As seen particularly in Table A2 of FIG. 1B, each of historical KPI values 124 corresponds to one of the types of KPIs 122.

For example, as seen in Table A2 of FIG. 1B, one of historical sets of KPIs 116, Historical Set of KPIs 1, includes, inter alia, types of KPIs 122 of yield, energy used and CO₂ emissions, having corresponding historical KPI values 124 of 96.2%, 120 kWh and 0.92 lb., respectively.

In one embodiment of the present invention, each of types of KPIs 122 of historical set of KPIs 116 relates particularly to that portion of the industrial process to which the corresponding historical SOP 114 relates. For example, if a historical SOP 114 relates particularly to a belt-furnace and subsequent cooling portion of a larger industrial process, corresponding historical set of KPIs 116 may relate to, inter alia, the yield of, energy used by and CO₂ emissions produced by the belt furnace and subsequent cooling portion of the larger industrial process, while not relating to yield, energy use or emissions of other portions of the industrial process.

In another embodiment of the present invention, each of types of KPIs 122 of historical set of KPIs 116 relates to more than just the portion of the industrial process to which the corresponding historical SOP 114 relates, for example the entirety of the industrial process. For example, if a historical SOP 114 relates particularly to a belt-furnace and subsequent cooling portion of a larger industrial process, corresponding historical set of KPIs 116 may relate to, inter alia, the yield of, energy used by and CO₂ emissions produced by an entirety of that portion of the industrial process performed in the same city in which the belt furnace and subsequent cooling portion of the larger industrial process is performed.

In a preferred embodiment of the present invention, some historical KPI values 124 are provided by measured values output by sensors (e.g., an amount of CO₂ emissions as measured by flow sensors in an exhaust chimney and an oven temperature measured by a thermocouple). It is appreciated that historical KPI values 124 may be raw sensor output or data extracted from sensor output, such as, inter alia, an average or standard deviation of raw sensor output, or ratios between outputs of different sensors. Additionally or alternatively, some historical KPI values 124 are provided by records maintained by human users (e.g., a production yield manually recorded by a shift manager).

It is appreciated that various ones of types of KPIs 122 in historical set of KPIs 116 may be mutually competing KPIs, and as a value of one of the mutually competing KPIs improves, a value of at least one of the other of the mutually competing KPIs worsens. For example, historical sets of KPIs 116 may include types of KPIs 122 including KPIs which are indicative of, inter alia, a monetary manufacturing cost and a quality of a finished product. In such a case, as the monetary manufacturing cost declines, finished product quality may decrease.

Additionally, different ones of types of KPIs 122 may have a higher relative importance to the industrial process than other ones of types of KPIs 122, and the relative importance of different ones of types of KPIs 122 may change based on various circumstances. Therefore, along with operational data 112, a set of KPI weighting coefficients 128 corresponding to types of KPIs 122 is preferably provided at step 110. KPI weighting coefficients 128 offer a numeric indication of a relative importance of various ones of types of KPIs 122. Preferably, each of types of KPIs 122 is associated with a particular KPI weighting coefficient 128, and together, all of the KPI weighting coefficients 128 add up to 100%.

It is appreciated that KPI weighting coefficients 128 support trade-off management in assessing which of historical SOPs 114 are associated with a particularly desirable historical set of KPIs 116, by quantifying which of types of KPIs 122 in each historical set of KPIs 116 are relatively more important than others of types of KPIs 122 in each historical set of KPIs 116. In one embodiment of the present invention, values of the KPI weighting coefficients 128 are selected by a human operator, such as a plant manager. In another embodiment of the present invention, values of the KPI weighting coefficients 128 are selected by a fully or partially automated process. Typically, values of the KPI weighting coefficients 128 may be changed depending on various circumstances and considerations.

As described hereinabove and as seen particularly in Table A3, each of multiplicity of historical SOPs 114 of operational data 112 is associated with a corresponding historical set of KPIs 116. Thus, for example, historical SOP 1 is associated with historical set of KPIs 1, historical SOP 2 is associated with historical set of KPIs 2, and historical SOP N₁ is associated with historical set of KPIs N₁.

Reference is now made particularly to FIG. 1C, which shows an association of an exemplary historical SOP 114 with a corresponding historical set of KPIs 116. For illustrative purposes, FIG. 1C corresponds to Historical SOP 1 of Table A1 of FIG. 1B, and each type of operating parameter 118 and associated historical OPVR 120 is represented by data points having a particular shape. Thus, in FIG. 1C, square-shaped data points represent flow rate, diamond-shaped data points represent temperature, triangular-shaped data points represent concentration and x-shaped data points represent pressure. For ease of representation, FIG. 1C has been greatly simplified, and the data has been normalized and is shown with arbitrary normalized units.

It is seen that each historical SOP 114 includes multiple types of operating parameters 118, each of which includes a multiplicity of operating parameter values 130, as indicated by a position of operating parameter value 130 relative to a vertical axis 132. Each of the operating parameter values 130 is associated with a different time, as indicated by a position of operating parameter value 130 relative to a horizontal axis 134.

It is appreciated that each of the times shown on horizontal axis 134 indicates a unique date and time combination, prior to step 110 of the method of FIG. 1. The intervals between various ones of operating parameter values 130 may be any useful intervals of time, such as, inter alia, seconds, minutes, shifts, days, weeks, months, quarters or years.

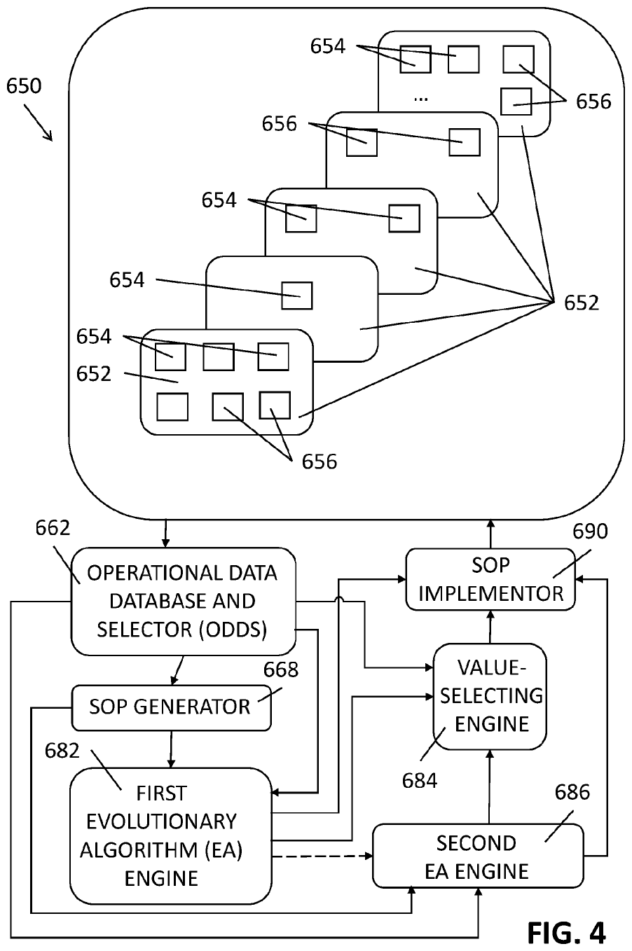

Additionally, each historical SOP 114 relates to an SOP-time interval 136, which is a difference between a first time t₁ associated with an operating parameter value 130 of the historical SOP 114 and a last time tₓ, such as, inter alia, tᵢ₊₁, tᵢ₊₂, tᵢ₊₃ or tᵢ₊₇, associated with an operating parameter value 130 of the historical SOP 114. The SOP-time interval 136 for each historical SOP 114 in operational data 112 is preferably identical or nearly identical to the SOP-time interval 136 of every other historical SOP 114 in operational data 112. SOP-time intervals 136 may have values of any suitable intervals of time, such as, inter alia, seconds, minutes, shifts, days, weeks, months, quarters or years. In a preferred embodiment of the present invention, SOP-time intervals 136 have values that are not arbitrary, but that indicate units of time that are particularly relevant to the industrial process, such as, inter alia, shifts, days, work-weeks, months, financial quarters or yearly seasons. It is appreciated that the SOPs 114 shown in FIGS. 4C, 4D and 4E do not span an entirety of the time range spanned by operational data 412.

Preferably, SOP-time intervals 136, when added together, are substantially equal to the time range spanned by operational data 112. Additionally, each of SOP-time intervals 136 preferably lie within the time range. Thus, for example, if operational data 112 spans a time range equal to one standard year, and each of SOP-time intervals 136 has a value of one day, there are preferably 365 SOP-time intervals 136, each of which represents one day within the year of the time range spanned by operational data 112, and which together add up to the year spanned by operational data 112.

Thus, each historical SOP 114 typically includes multiple operating parameter values 130. For each type of operating parameter 118, operation parameter values 130 associated with a single historical SOP 114 together define OPVR 120, which is also referred to herein as a historical single-SOP OPVR 120.

As seen particularly in FIGS. 1C & 1D, for each type of operating parameter 118, for each SOP-time interval 136, at least one of operating parameter values 130 of each historical OPVR 120 is a historical minimum parameter value 142 and at least one at least one of operating parameter values 130 of each historical OPVR 120 is a historical maximum parameter value 144. A difference between historical maximum parameter value 144 and historical minimum parameter value 142 defines a historical OPVR spread 146 for each type of operating parameter 118. As is readily apparent, a value of OPVR spread 146 is dependent on a choice of SOP-time intervals 136.

For example, as seen particularly in FIG. 1D, if SOP-time interval 136 extends from t₁ to t₄ on horizontal axis 134, the CONCENTRATION operating parameter 118 of the SOP 114 shown in FIG. 1D is characterized by a historical minimum parameter value 142 of approximately 18 normalized units of vertical axis 132 and a historical maximum parameter value 144 of approximately 40 normalized units of vertical axis 132. Thus, historical OPVR spread 146 of the CONCENTRATION operating parameter 118 of the SOP 114 is characterized by a value of approximately 22 arbitrary units of vertical axis 132.

However, if SOP-time interval 136 extends from t₈ to t₉ on horizontal axis 134, the CONCENTRATION operating parameter 118 of the SOP 114 shown in FIG. 1D is characterized by a historical minimum parameter value 142 of approximately 21 normalized units of vertical axis 132 and a historical maximum parameter value 144 of approximately 23 normalized units of vertical axis 132. Thus, historical OPVR spread 146 of the CONCENTRATION operating parameter 118 of the SOP 114 is characterized by a value of approximately 2 arbitrary units of vertical axis 132.

As seen particularly in FIG. 1E, which shows selected, simplified data from selected, simplified SOPs 114 of operational data 112, for each type of operating parameter 118, the values of historical OPVR spreads 146 of various ones of historical SOPs 114 of operational data 112 typically differ from that the values of corresponding historical OPVR spreads 146 of other ones of historical SOPs 114 of operational data 112.

In a preferred embodiment of the present invention, for operational data 112, a single average historical OPVR spread 152 is defined for each of the types of operating parameters 118. Preferably, for each of the types of operating parameters 118, the average historical OPVR spread 152 is an average of the historical OPVR spreads 146 of that type of operating parameter 118 of some or all historical SOPs 114 of operational data 112. It is appreciated that a value of average historical OPVR spread 152 is dependent on a size of SOP-time interval 136.

For example, oval A of FIG. 1E shows historical OPVR spreads 146 for the CONCENTRATION operating parameter 118 of the SOPs 114 shown in FIG. 1E. It is noted that ellipses in FIG. 1E denote other SOPs 114 or OPVR spreads 146 in operational data 112, which, for simplicity, are not shown in FIG. 1E. As seen in oval A of FIG. 1E, average historical OPVR spread 152 for the CONCENTRATION operating parameter 118 is an average of the historical OPVR spreads 146 for the CONCENTRATION operating parameter 118 within operational data 112.

The single average historical OPVR spread 152 may be calculated based on any suitable type of average, including, inter alia, a mean, mode or median. Similarly, the average may be a weighted average, in which each of the historical SOPs 114 and its associated historical OPVR spread 146 is characterized by a weighting coefficient, and the weighting coefficient is used in calculating the average historical OPVR spread 152. The weighting coefficient may be any suitable weighting coefficient.

In a first example, the weighting coefficient of each of the historical SOPs 114 and its associated historical OPVR spread 146 may be a quantitative indication of a recency of each historical SOP 114. In such a case, for example, historical OPVR spreads 146 of relatively recent historical SOPs 114 may be given a higher weighting coefficient than historical OPVR spreads 146 of historical SOPs 114 from further in the past.

In a second example, the weighting coefficient of each of the historical SOPs 114 and its associated historical OPVR spread 146 may be related to the historical set of KPIs 116 with which the historical SOP 114 is associated. In such a case, for example, historical OPVR spreads 146 of historical SOPs 114 associated with relatively desirable historical sets of KPIs 116 may be given higher weighting coefficients than historical OPVR spreads 146 of historical SOPs 114 associated with relatively undesirable historical sets of KPIs 116.

In addition to the average historical OPVR spread 152, one or more historical multiple-SOP OPVRs, each having a historical multiple-SOP OPVR spread 162, may also be defined. Preferably, one multiple-SOP OPVR is defined for each of the types of operating parameters 118. In a preferred embodiment of the present invention, each of the multiple-SOP OPVRs is formed from a multiplicity of historical single-SOP OPVRs 120.

More specifically, for each of the types of operating parameters 118, the corresponding historical multiple-SOP OPVR is preferably an OPVR extending from a historical multiple-SOP minimum parameter value 164, which is the lowest of historical minimum parameter values 142 of the multiplicity of historical single-SOP OPVR 120, to a historical multiple-SOP maximum parameter value 166, which is the highest historical maximum parameter value 144 of the multiplicity of historical single-SOP OPVR 120. Historical multiple-SOP minimum parameter value 164 and historical multiple-SOP maximum parameter value 166 are separated by historical multiple-SOP OPVR spread 162.

For example, oval B of FIG. 1E shows historical OPVR spreads 146 for the CONCENTRATION operating parameter 118 of the SOPs 114 shown in FIG. 1E. As described hereinabove, ellipses in FIG. 1E denote other SOPs 114 or OPVR spreads 146 in operational data 112, which, for simplicity, are not shown in FIG. 1E. As seen in oval B of FIG. 1E, historical multiple-SOP OPVR spread 162 for the CONCENTRATION operating parameter 118 extends from historical multiple-SOP minimum parameter value 164 for the CONCENTRATION operating parameter 118 to historical multiple-SOP maximum parameter value 166 for the CONCENTRATION operating parameter 118.

Together, types of operating parameters 118 and the historical multiple-SOP OPVRs form a historical combined SOP. In one embodiment of the present invention, operational data 112 includes a single historical combined SOP. In another embodiment of the present invention, operational data 112 includes two or more historical combined SOPs. If operational data 112 includes two or more historical combined SOPs, each historical combined SOPs is preferably formed from a different multiplicity of historical single-SOP OPVR 120.

As discussed hereinabove with particular reference to FIG. 1B, each historical SOP 114 is associated with a corresponding historical set of KPIs 116. Returning now to FIG. 1C, it is seen that a KPI-time interval 176 corresponds to SOP-time interval 136. Within KPI-time interval 176, historical set of KPIs 116 preferably includes at least one historical KPI value 124 for each type of KPIs 122. For ease, in FIG. 1C, positions of historical KPI values 124 relative to a horizontal axis 184 are nearly identical to positions of corresponding operating parameter values 130 relative to horizontal axis 134, indicating that KPI values 124 and corresponding operating parameter values 130 were sampled at identical or nearly identical times.

However, in another embodiment of the present invention, KPI values 124 and corresponding operating parameter values 130 are not sampled at identical or nearly identical times. KPI values 124 and corresponding operating parameter values 130 may be sampled at any suitable sampling times with any suitable sampling rates. It is highly preferably, however, that for each corresponding pair of historical SOP 114 and historical set of KPIs 116, SOP-time interval 136 is substantially identical to KPI-time interval 176.

In a preferred embodiment of the present invention, a shared timestamp or timestamps, indicated by an identical or nearly identical position of operating parameter values 130 relative to horizontal axis 134, causes various ones of single-SOP OPVRs 120 corresponding to various ones of types of operating parameters 118 to be collected into a single SOP 114. Similarly, a shared timestamp or timestamps, indicated by an identical or nearly identical position of various KPI values 124 relative to horizontal axis 134, causes various KPI values 124 corresponding to various ones of types of KPIs 122 to be collected into a single set of KPIs 116. Additionally, the shared timestamp or timestamps causes an SOP 114 to be associated with a corresponding one of sets of KPIs 116.

It is appreciated that as part of or prior to step 110, operational data 112 is preferably cleaned in a pre-processing step. The cleaning and pre-processing of operational data 112 preferably includes traceability operations, in which KPI values 124 and corresponding operating parameter values 130 are moved along axes 184 and 134, respectively, to synchronize operational data 112. Additionally, during cleaning and pre-processing, operational data 112 is examined for outlying data points, and data determined to be, for example, unreliable or irrelevant is either removed or replaced.

Turning once more to FIG. 1A, at an optional next step 210, at least one additional SOP is generated from operational data 112. The at least one additional SOP generated at step 210 includes the plurality of types of operating parameters 118 which is included in historical SOPs 114 of operational data 112, as well as a plurality of additional OPVRs. Each of the plurality of additional OPVRs preferably corresponds to a particularly desirable one of historical sets of KPIs 116.

In a preferred embodiment of the present invention, in order to identify historical OPVRs 120 which are associated with particularly desirable historical sets of KPIs 116 for a particular type of operating parameters 118, a one-dimensional optimization is performed as part of step 210. The one-dimensional optimization of step 210 evaluates each type of operating parameter 118 independently of the others of types of operating parameter 118.

As part of the one-dimensional optimization of step 210, for each type of operating parameter 118, the corresponding one of multiple-SOP OPVR is divided into sub-OPVRs. The multiple-SOP OPVR may be divided into any suitable number of sub-OPVRs, for example, 2, 3, 4, 5 or 6 OPVRs. In one embodiment of the present invention, each of the multiple-SOP OPVRs is divided into sub-OPVRs each having a time interval of substantially the same size as time intervals of others of sub-OPVRs. In another embodiment of the present invention, each of the multiple-SOP OPVRs is divided sub-OPVRs each having a time interval not of substantially the same size as time intervals of others of sub-OPVRs. Once the multiple-SOP OPVRs have been divided into sub-OPVRs, the one-dimensional optimization of step 210 identifies and selects the sub-OPVR which is associated with a more desirable set of KPIs than the others of the sub-OPVRs.

Preferably, the one-dimensional optimization of step 210 is performed separately for each of types of operating parameters 118, thereby generating the at least one additional SOP. It is appreciated that the additional SOP may be an SOP that is either possible to implement or impossible to implement. For example, the additional OPVRs of the additional SOP may, when taken together, violate physical laws. For example, the additional SOP may include a temperature range for a gas and a pressure range for the gas that together violate the ideal gas law of pV=nRT, where P is a pressure of a gas, V is a volume of the gas, n is an amount of the gas, typically in moles, R is the molar gas constant, and T is a temperature of the gas.

Thereafter, at a next step 228, an evolutionary algorithm (EA) is applied to operational data 112, thereby identifying an optimal SOP. Preferably, in a case wherein the method includes step 210, the EA is also applied to at least one of the additional SOPs generated at step 210. The EA of step 228 may be any suitable EA, for example, a GA, an EA similar to, inter alia, the EAs disclosed in any of Deb, K., Pratap, A., Agarwal, S. and Meyarivan, T. A. M. T., 2002. A fast and elitist multiobjective genetic algorithm: NSGA-II. IEEE transactions on evolutionary computation, 6(2), pp. 182-197; Deb, K. and Jain, H., 2013. An evolutionary many-objective optimization algorithm using reference-point-based nondominated sorting approach, part I: solving problems with box constraints. IEEE transactions on evolutionary computation, 18(4), pp. 577-601; and Jain, H. and Deb, K., 2013. An evolutionary many-objective optimization algorithm using reference-point based nondominated sorting approach, part II: Handling constraints and extending to an adaptive approach. IEEE Transactions on evolutionary computation, 18(4), pp. 602-622. In a preferred embodiment of the present invention, the EA of step 228 is a genetic algorithm.

Turning now particularly to FIG. 1F, which is a simplified flowchart illustrating sub-steps of step 228 of FIG. 1A, it is seen that at a first sub-step 230, the EA is initialized, or seeded with an initial population of SOPs. In other words, an initial population of SOPs is supplied to the EA at sub-step 230. Typically, the initial population of SOPs supplied to the EA at sub-step 230 includes at least a subset of historical SOPs 114. Any suitable initial population may be used at sub-step 230, such as a random initial population or a non-random initial population.

In a preferred embodiment of the present invention, the initial population of SOPs supplied at sub-step 230 is at least partially non-random, and at least some historical SOPs 114, in the subset of historical SOPs 114 included in the initial population of SOPs, are historical SOPs 114 which are associated with a particularly desirable historical set of KPIs 116, as at least partially determined by KPI weighting coefficients 128 provided at step 110.

In an additional preferred embodiment of the present invention, the initial population of SOPs supplied at sub-step 230 is at least partially non-random, and includes at least one of the additional SOPs generated at step 210.

In yet another preferred embodiment of the present invention, the initial population of SOPs supplied at sub-step 230 is at least partially non-random, and includes both at least some historical SOPs 114 which are associated with particularly desirable historical set of KPIs 116, as determined by KPI weighting coefficients 128 provided at step 110, and at least one of the additional SOPs generated at step 210.

At a next sub-step 232, the initial population supplied at sub-step 230, which preferably includes at least some of operational data 112, and more preferably includes a subset of historical SOPs 114 and the at least one additional SOP generated at step 210, is employed in breeding a multiplicity of candidate SOPs 234.

As part of sub-step 232, members of the initial population supplied at sub-step 230 are selected, mated and mutated, thereby generating candidate SOPs 234. As seen particularly in Table B1 of FIG. 1B, each of candidate SOPs 234 includes plurality of types of operating parameters 118 and a plurality of candidate OPVRs 236, each of candidate OPVRs 236 corresponding to one of types of operating parameters 118. In an analogous manner to that of historical OPVRs 120, each of candidate OPVRs 236 preferably has a candidate minimum parameter value and a candidate maximum parameter value. A difference between the candidate minimum parameter value and the candidate maximum parameter value defines a candidate OPVR spread. Thus, the candidate minimum parameter value and the candidate maximum parameter value are separated by the candidate OPVR spread.

In a preferred embodiment of the present invention, a value of each of the candidate OPVR spreads associated with a type of operating parameter 118 is identical with or nearly identical with a value of average historical OPVR spread 152 of that type of operating parameter 118.

Additionally, each candidate SOP 234 is preferably associated with a candidate set of KPIs 238. Each candidate set of KPIs 238 typically includes plurality of types of KPIs 122 and a plurality of candidate KPI values 240, which together quantify a desirability of the candidate SOP 234 with which the candidate set of KPIs 238 is associated. As seen particularly in Table B2 of FIG. 1B, each of candidate KPI values 240 corresponds to one of the types of KPIs 122. It is appreciated that candidate sets of KPIs 238 are typically projected KPIs, and candidate KPI values 240 are typically estimated by the method of FIG. 1.

Returning now to FIG. 1F, at a next sub-step 242, a cost function is applied to candidate SOPs 234, thereby identifying a multiplicity of desirable candidate SOPs. Preferably, the cost function of sub-step 242 includes thresholding functionality. If at least some candidate OPVRs 236 of a candidate SOP 234 occur in less than a predetermined percentage of operational data 112, then that candidate SOP 234 is rejected by the thresholding functionality of the cost function.

The cost function of sub-step 242 proceeds to analyze each candidate SOP 234 that is not rejected by the thresholding functionality of the cost function. Preferably, in each iteration of sub-step 242, for each candidate SOP 234, the cost function of sub-step 242 analyzes operational data 112 to determine whether set of KPIs 238 associated with each of candidate SOPs 234 generated at an iteration of sub-step 232 immediately preceding that iteration of sub-step 242 is more or less desirable than sets of KPIs 238 associated with others of candidate SOPs 234 generated at the iteration of sub-step 232 immediately preceding that iteration of sub-step 242. In a preferred embodiment of the present invention, the desirability of historical sets of KPIs 116 is at least partially determined by KPI weighting coefficients 128 provided at step 110.

In a preferred embodiment of the present invention, the cost function of sub-step 242 includes all of a Mann-Whitney Stochastic Order analysis, a period dominancy analysis and a recency weighting. In another preferred embodiment of the present invention, the cost function of sub-step 242 includes at least one of a Mann-Whitney Stochastic Order analysis, a period dominancy analysis and a recency weighting.

The Mann-Whitney Stochastic Order analysis used in the cost function of sub-step 242 may be any suitable Mann-Whitney Stochastic Order analysis, such as, inter alia, an analysis similar to that disclosed in H. B. Mann, D. R. Whitney “On a Test of Whether one of Two Random Variables is Stochastically Larger than the Other,” The Annals of Mathematical Statistics, Ann. Math. Statist. 18(1), 50-60, (March, 1947) and/or Nachar, Nadim. (2008). The Mann-Whitney U: A Test for Assessing Whether Two Independent Samples Come from the Same Distribution. Tutorials in Quantitative Methods for Psychology. 4. 10.20982/tqmp.04.1.p013.

The period dominancy analysis used in the cost function of sub-step 242 preferably evaluates a desirability of candidate SOPs 234 by evaluating each candidate SOP 234 for each of time intervals 136 in the time range spanned by operational data 112 separately. More specifically, each historical SOP 114 is split into two portions, which need not be contiguous. A first portion of historical SOP 114 is that portion of historical SOP 114 in which historical OPVRs 120 are within the bounds of candidate OPVRs 236. The first portion of historical SOP 114 has a first historical set of KPIs. A second portion of historical SOP 114 is that portion of historical SOP 114 in which the historical OPVRs 120 are outside of the bounds of candidate OPVRs 236. The second portion of historical SOP 114 has a second historical set of KPIs.

The period dominancy analysis of the cost function evaluates whether or not the first set of historical KPIs is more desirable than the second set of historical KPIs. It is appreciated that the evaluation may be performed using a Mann-Whitney Stochastic Order analysis, or any other suitable method. If the first historical set of KPIs is more desirable than the second historical set of KPIs, then the period dominancy analysis concludes that for the time interval 136 of that historical SOP 114, candidate SOP 234 is more desirable than other SOPs, and the cost function assigns that candidate SOP 234 a first value, such as 1, for the specific time interval 136 being evaluated. If, however, the first historical set of KPIs is less desirable than the second historical set of KPIs, then the period dominancy analysis concludes that for the time interval 136 being evaluated for that historical SOP 114, candidate SOP 234 is less desirable than other SOPs, and the cost function assigns that candidate SOP 234 a second value, such as 0, for that time interval 136.

The period dominancy analysis of the cost function repeats this process for each time interval 136 in the time range spanned by operational data 112, then assigns an overall score to that candidate SOP 234, based on the individual values for each time interval 136. The candidate SOPs 234 with the most desirable overall scores are identified as desirable candidate SOPs.

The recency weighting used in the cost function of sub-step 242 preferably assigns a higher weighting coefficient to portions of operational data 112 which are relatively recent than to portions of operational data 112 from further in the past. More specifically, the cost function of sub-step 242 preferably evaluates, for each candidate SOP 234, whether those portions of operational data 112 having historical OPVRs 120 within bounds of the candidate OPVRs 236 of that candidate SOP 234 are associated with KPIs which are more desirable than KPIs associated with those portions of operational data 112 having historical OPVRs 120 outside the bounds of the candidate OPVRs 236 of that candidate SOP 234. The cost function preferably assigns that candidate SOP 234 a first value, such as 1, for those portions of operational data 112 which indicate that candidate SOP 234 is a relatively desirable SOP, and a second value, such as 0, for those portions of operational data 112 which indicate that candidate SOP 234 is a relatively undesirable SOP. It is appreciated that the evaluation may be performed using a Mann-Whitney Stochastic Order analysis, or any other suitable method.

The recency weighting used in the cost function of sub-step 242 then modifies the values assigned to the candidate SOP 234. Typically, the recency weighting functionality of the cost function multiplies the values assigned to the candidate SOP 234 by a weighting coefficient. The weighting coefficients for recent portions of operational data 112 preferably have higher values than the weighting coefficients for less recent portions of operational data 112.

The recency weighting used in the cost function of sub-step 242 may be any suitable type of recency weighting. In a preferred embodiment of the present invention, the recency weighting includes an exponential decay function, in which more recent portions of operational data 112 are associated with weighting coefficients that are exponentially larger than those weighting coefficients associated with less recent portions of operational data 112. In another preferred embodiment of the present invention, the recency weighting includes another type of function, such as, inter alia, a linear function, a polynomial function, a root function, or a logarithmic function.

At a next sub-step 244, a decision is made whether or not to breed additional candidate SOPs 234. If additional candidate SOPs 234 are to be bred, the method returns to sub-step 232 and at least some of the desirable candidate SOPs identified at sub-step 242 are employed in breeding an additional multiplicity of candidate SOPs 234. As part of this iteration of sub-step 232, at least some of the desirable candidate SOPs identified at sub-step 242 are selected, mated and mutated, thereby generating additional candidate SOPs 234.

It is appreciated that the method can return from sub-step 244 to sub-step 232 any suitable number of times. For example, the method can return from sub-step 244 to sub-step 232 over 100 times, over 200 times, over 300 times, over 400 times, over 500 times, over 700 times, over 1,000 times, over 2,000 times, over 3,000 times, over 4,000 times or over 5,000 times. In a preferred embodiment of the present invention, the number of times that method returns from sub-step 244 to sub-step 232 is at least partially based on at least one of a computational time available, computational resources available, and a convergence time of optimization problem being solved by the evolutionary algorithm of the method.

If at sub-step 244, a decision is made not to breed additional candidate SOPs 234, the method proceeds to sub-step 248, at which the method selects at least one optimal SOP 254 from candidate SOPs 234. Preferably optimal SOP or SOPs 254 are selected from that multiplicity of desirable candidate SOPs identified from candidate SOPs 234 which was generated during a final iteration of sub-step 242, i.e., the iteration of sub-step 242 which was run immediately preceding that iteration of sub-step 244 which was run immediately preceding sub-step 248.

As seen particularly in Table C1 of FIG. 1B, optimal SOP 254 preferably includes types of operating parameters 118 and a plurality of optimal OPVRs 256, each of optimal OPVRs 256 corresponding to one of types of operating parameters 118. Similar to historical OPVRs 120 and candidate OPVRs 236, each of optimal OPVRs 256 typically has a minimum optimal parameter value and a maximum optimal parameter value. A difference between the minimum optimal parameter value and the maximum optimal parameter value defines an optimal OPVR spread. Thus, the minimum optimal parameter value and the maximum optimal parameter value are separated by the optimal OPVR spread.

In a preferred embodiment of the present invention, each of optimal OPVRs 256 lies entirely within a corresponding one of the historical multiple-SOP OPVRs. In other words, preferably, the minimum optimal parameter value is greater than or equal to historical multiple-SOP minimum parameter value 164, and the maximum optimal parameter value is less than or equal to historical multiple-SOP maximum parameter value 166 for the historical multiple-SOP OPVR corresponding to that type of operating parameter 118 to which the optimal OPVR 256 corresponds.

Additionally, each optimal SOP 254 is preferably associated with an optimal set of KPIs 262. Each optimal set of KPIs 262 typically includes plurality of types of KPIs 122 and a plurality of optimal KPI values 264, which together quantify a desirability of the optimal SOP 254 with which the optimal set of KPIs 262 is associated. As seen particularly in Table C2 of FIG. 1B, each of optimal KPI values 264 corresponds to one of the types of KPIs 122. It is appreciated that optimal sets of KPIs 262 are typically projected KPIs, and optimal KPI values 264 are typically estimated by the method of FIG. 1A.

It is appreciated that as used herein, “optimal” is used to mean particularly desirable and preferably a best. Thus, an optimal SOP is an SOP which is associated with a particularly desirable optimal set of KPIs 262, as at least partially determined by KPI weighting coefficients 128 provided at step 110.

Turning once more to FIGS. 1B & 1F, at an optional next sub-step 270, the method preferably provides a set of KPI weighting ranges 272 for which optimal SOP 254 is particularly suitable. As discussed hereinabove with reference to FIG. 1A, KPI weighting coefficients 128 are provided at step 110 for types of KPIs 122. KPI weighting coefficients 128 offer a numeric indication of relative importance of various ones of types of KPIs 122. Also, as described hereinabove, KPI weighting coefficients 128 are subject to change based on various circumstances and considerations.

Since optimal SOP 254 is selected at least partially based on the KPI weighting coefficients 128 provided at step 110, a change in KPI weighting coefficients 128 may result in a change in which candidate SOP 234 is identified as an optimal SOP 254. However, not every change in the KPI weighting coefficients 128 necessarily results in a change in which candidate SOP 234 is identified as an optimal SOP 254.

Therefore, if a user is aware of a change in the KPI weighting coefficients 128, the user may choose to run the method again, in order to either confirm that a previously identified optimal SOP 254 is still optimal for the updated KPI weighting coefficients 128, or to identify an updated optimal SOP 254 based on the updated KPI weighting coefficients 128.

In order to save time, and reduce a number of times which the method is run, the method preferably provides KPI weighting ranges 272 at sub-step 270. KPI weighting ranges 272 indicate ranges of KPI weighting coefficients 128 for which the optimal SOP 254 identified at sub-step 248 is particularly suitable. Thus, if the industrial process is subject to change in KPI weighting coefficients 128 after step 110, the updated KPI coefficients 128 may be compared to KPI weighting ranges 272 provided at sub-step 270 in order to check whether or not optimal SOP 254 identified at sub-step 248 is still optimal for the updated KPI weighting coefficients 128.

For example, if the YIELD type of KPI 122 were assigned a KPI weighting coefficient 128 of 55% at step 110, and later the KPI weighting coefficient 128 associated with the YIELD type of KPI 122 was changed to 50%, a user can preferably consult KPI weighting ranges 272 provided at sub-step 270 and confirm that the KPI weighting coefficient 128 associated with the YIELD type of KPI 122 is still within the KPI weighting range 272 for the YIELD type of KPI 122 of 50-60%, and therefore, assuming that all other KPI weighting coefficients 128 are also still within the KPI weighting ranges 272 of corresponding types of KPIs 122, there is no need to run the method of FIG. 1A again to find a new optimal SOP 254.

Additionally, as seen particularly in Table C3 of FIG. 1B, in a preferred embodiment of the present invention, at sub-step 248, at least one additional optimal SOP 254 is selected from candidate SOPs 234. Preferably, each additional optimal SOP 254 is associated with a corresponding additional optimal set of KPIs 262. For each of additional optimal SOPs 254 there is preferably provided an associated, preferably unique, additional set of KPI weighting ranges 272, which are preferably provided at sub-step 270. Additional sets of KPI weighting ranges 272 indicate for which values of KPI weighting coefficients 128 respective additional optimal SOPs 254 are particularly suitable. Thus, if the industrial process is subject to change in the KPI weighting coefficients 128 after step 110, the updated KPI coefficients 128 may be compared to all KPI weighting ranges 272 provided at sub-step 270 in order to check which of optimal SOPs 254 identified at sub-step 248 is most suitable for the updated KPI weighting coefficients 128.

For example, if the YIELD type of KPI 122 were assigned a KPI weighting coefficient 128 of 55% at step 110, and later the KPI weighting coefficient 128 associated with the YIELD type of KPI 122 was changed to 63%, and the KPI weighting range 272 for the YIELD type of KPI 122 is 50-60% for optimal SOP 254, a user can preferably consult additional KPI weighting ranges 272 of additional optimal SOPs 254 provided at sub-step 270, and identify an additional optimal SOP 254 having a KPI weighting range 272 for the YIELD type of KPI 122 including 63%, as well as KPI weighting ranges 272 including all other KPI weighting coefficients 128 corresponding types of KPIs 122. The user can preferably select that additional optimal SOP 254 as the desirable optimal SOP 254 to implement in the industrial process, with no need to run the method of FIG. 1A again in order to find a new optimal SOP 254.

Turning once more to FIG. 1A, and as seen particularly in Table C1 of FIG. 1B, at an optional next step 282, an optimal operating parameter value 286 is preferably provided for at least one optimal OPVR 256. More preferably, an optimal operating parameter value 286 is preferably provided for each of optimal OPVRs 256. Optimal operating parameter value 286 is preferably a particularly desirable value within optimal OPVR 256 for that type of operating parameter 118. In other words, if the industrial process were to attempt to maintain a particular value within optimal OPVR 256, the method recommends attempting to maintain the value of optimal operating parameter value 286.

In one embodiment of the present invention, optimal operating parameter value 286 is a parameter value that is associated with a particularly desirable optimal set of KPIs 262. In another embodiment of the present invention, optimal operating parameter value 286 is a parameter value that occurs particularly often in operational data 112, indicating that optimal operating parameter value 286 is particularly easy to achieve and maintain in the industrial process.

As discussed hereinabove, human operators are often hesitant to make large changes in current operating setups based on suggestions from artificial intelligence programs, particularly for large-scale, expensive, and often potentially dangerous, industrial processes. Therefore, in addition to the optimal SOP 254 provided in step 282, the present invention preferably also provides partially-optimal SOPs. As described in more detail hereinbelow, in the embodiment of the present invention described with reference to FIGS. 1A-1F, by implementing the one or more partially-optimal SOPs, an operator can change operating parameters of the industrial process gradually, by changing values or value ranges of a few types of operating parameters 118 at a time. This is in contrast to changing values or value ranges of many or all types of operation parameters 118 simultaneously, as would result from implementing an optimal SOP 254 immediately, without an intermediate implementation of any of the one or more partially-optimal SOPs.

As seen further in FIG. 1A, at an optional next step 288, at least one partially-optimal SOP 294 is provided. As seen particularly in Table D1 of FIG. 1B, each of partially-optimal SOPs 294 preferably includes plurality of types of operating parameters 118 and a plurality of partially-optimal OPVRs 296, each of partially-optimal OPVRs 296 corresponding to one of types of operating parameters 118. Similar to optimal OPVRs 256, each of partially-optimal OPVRs 296 typically has a minimum partially-optimal parameter value and a maximum partially-optimal parameter value. A difference between the minimum partially-optimal parameter value and the maximum partially-optimal parameter value defines a partially-optimal OPVR spread. Thus, the minimum partially-optimal parameter value and the maximum partially-optimal parameter value are separated by the partially-optimal OPVR spread.

In a preferred embodiment of the present invention, each of partially-optimal OPVRs 296 lies entirely within a corresponding one of the historical multiple-SOP OPVRs. In other words, preferably, the minimum partially-optimal parameter value is greater than or equal to historical multiple-SOP minimum parameter value 164, and the maximum partially-optimal parameter value is less than or equal to historical multiple-SOP maximum parameter value 166 for the historical multiple-SOP OPVR corresponding to that type of operating parameter 118 to which the partially-optimal OPVRs 296 corresponds. Thus, each of the partially-optimal OPVR spreads is preferably smaller than a corresponding one of historical multiple-SOP OPVR spreads 162.

Additionally, each of partially-optimal OPVRs 296 preferably at least partially overlap a corresponding one of optimal OPVRs 256. In other words, preferably, the minimum partially-optimal parameter value is less than or equal to the minimum optimal historical value, and/or the maximum partially-optimal parameter value is greater than or equal to the maximum optimal parameter value for the optimal OPVR 256 corresponding to that type of operating parameter 118 to which the partially-optimal OPVR 296 corresponds. Thus, each of the partially-optimal OPVR spreads is preferably larger than a corresponding one of the optimal OPVR spreads.

Preferably, the one or more partially-optimal SOPs 294 provided at step 288 are identified by applying a non-evolutionary algorithm to optimal SOP 254. More specifically, partially-optimal OPVRs 296 of partially-optimal SOPs 294 preferably are of two types: some partially-optimal OPVRs 296 are substantially identical with ones of historical OPVRs 120, preferably ones of the historical multiple-SOP OPVRs, and others of partially-optimal OPVRs 296 are substantially identical with ones of optimal OPVRs 256. Thus, as described hereinabove, by implementing one or more partially-optimal SOPs 294, changes to the industrial process are made gradually, by changing values or value ranges of a few types of operating parameters 118 each time a different partially-optimal SOP 294 is implemented.

Thus, partially-optimal OPVRs 296 of each of the one or more partially-optimal SOPs 294 preferably include a first sub-set of partially-optimal OPVRs and a second sub-set of partially-optimal OPVRs. The first sub-set of partially-optimal OPVRs corresponds to a first sub-set of types of operating parameters 118, where the first sub-set of partially-optimal OPVRs is substantially identical with a corresponding sub-set of optimal OPVRs 256. The second sub-set of partially-optimal OPVRs corresponds to a second sub-set of types of operating parameters 118, where the second sub-set of partially-optimal OPVRs is substantially identical with a corresponding sub-set of the historical multiple-SOP OPVRs.

Additionally, each partially-optimal SOP 294 is preferably associated with a partially-optimal set of KPIs 302. Each partially-optimal set of KPIs 302 typically includes plurality of types of KPIs 122 and a plurality of partially-optimal KPI values 304, which together quantify a desirability of the partially-optimal SOP 294 with which the partially-optimal set of KPIs 302 is associated. As seen particularly in Table D2 of FIG. 1B, each of partially-optimal KPI values 304 corresponds to one of the types of KPIs 122. It is appreciated that partially-optimal sets of KPIs 302 are typically projected KPIs, and partially-optimal KPI values 304 are typically estimated by the method of FIG. 1A.

As seen additionally in Table D2 of FIG. 1B, the method preferably also provides a set of KPI weighting ranges 308 for which partially-optimal SOP 294 is particularly suitable. As discussed hereinabove with reference to FIG. 1A, KPI weighting coefficients 128 are preferably provided at step 110 for types of KPIs 122. KPI weighting coefficients 128 offer a numeric indication of relative importance of various ones of types of KPIs 122. Also, as described hereinabove, the KPI weighting coefficients 128 provided at step 110 are subject to change based on various circumstances and considerations.

Since partially-optimal SOP 294 is selected at least partially based on the KPI weighting coefficients 128 provided at step 110, a change in the KPI weighting coefficients 128 may result in a change in which candidate SOP 234 is identified as a partially-optimal SOP 294. However, not every change in the KPI weighting coefficients 128 necessarily results in a change in which candidate SOP 234 is identified as a partially-optimal SOP 294.

Therefore, if a user is aware of a change in the KPI weighting coefficients, 128, the user may choose to run the method again, in order to either confirm that a previously provided partially-optimal SOP 294 is still partially-optimal for the updated KPI weighting coefficients 128, or to identify an updated partially-optimal SOP 294 based on the updated KPI weighting coefficients 128.

In order to save time, and reduce a number of times which the method is run, the method preferably provides KPI weighting ranges 308. KPI weighting ranges 308 indicate ranges of KPI weighting coefficients 128 for which the partially-optimal SOP 294 provided at step 288 is particularly suitable. Thus, if the industrial process is subject to change in the KPI weighting coefficients 128 after step 110, the updated KPI coefficients 128 may be compared to KPI weighting ranges 308 in order to check whether or not partially-optimal SOP 294 provided at step 288 is still optimal for the updated KPI weighting coefficients 128.

For example, if the YIELD type of KPI 122 were assigned a KPI weighting coefficient 128 of 55% at step 110, and later the KPI weighting coefficient 128 associated with the YIELD type of KPI 122 was changed to 50%, a user can preferably consult KPI weighting ranges 308 provided at sub-step 288 and confirm that the KPI weighting coefficient 128 associated with the YIELD type of KPI 122 is still within the KPI weighting range 308 for the YIELD type of KPI 122 of 45-60%, and therefore, assuming that all other KPI weighting coefficients 128 are also still within the KPI weighting ranges 308 of corresponding types of KPIs 122, there is no need to run the method of FIG. 1A again to find a new partially-optimal SOP 294.

Additionally, as seen particularly in Table D3 of FIG. 1B, in a preferred embodiment of the present invention, at least one additional partially-optimal SOP 294 is provided at step 288. Preferably, each additional partially-optimal SOP 294 is associated with a corresponding additional partially-optimal set of KPIs 302. For each of additional partially-optimal SOPs 294 there is preferably provided an associated, preferably unique, additional set of KPI weighting ranges 308. Additional sets of KPI weighting ranges 308 indicate for which values of KPI weighting coefficients 128 respective additional partially-optimal SOPs 294 are particularly suitable. Thus, if the industrial process is subject to change in the KPI weighting coefficients 128 after step 110, the updated KPI coefficients may be compared to all KPI weighting ranges 308 in order to check which of partially-optimal SOPs 294 provided at step 288 is most suitable for the updated KPI weighting coefficients 128.

For example, if the YIELD type of KPI 122 were assigned a KPI weighting coefficient 128 of 55% at step 110, and later the KPI weighting coefficient 128 associated with the YIELD type of KPI 122 was changed to 63%, and the KPI weighting range 308 for the YIELD type of KPI 122 is 45-60% for partially-optimal SOP 294, a user can preferably consult additional KPI weighting ranges 308 of additional partially-optimal SOPs 294 provided at sub-step 288, and identify an additional partially-optimal SOP 294 having a KPI weighting range 308 for the YIELD type of KPI 122 including 63%, as well as KPI weighting ranges 308 including all other KPI weighting coefficients 128 corresponding types of KPIs 122. The user can preferably select that additional partially-optimal SOP 294 as the desirable partially-optimal SOP 294 to implement in the industrial process, with no need to run the method of FIG. 1A again in order to find a new partially-optimal SOP 294.

As seen particularly in FIG. 1A and Table D1 of FIG. 1B, at an optional next step 312, an optimal partially-optimal operating parameter value 316 is provided for at least one of partially-optimal OPVRs 296. More preferably, an optimal partially-optimal operating parameter value 316 is preferably provided for each of partially-optimal OPVRs 296. Optimal partially-optimal operating parameter value 316 is preferably a particularly desirable value within partially-optimal OPVR 296 for that type of operating parameter 118. In other words, if the industrial process were to attempt to maintain a particular value within partially-optimal OPVR 296, the method recommends attempting to maintain the value of optimal partially-optimal operating parameter value 316.

In one embodiment of the present invention, optimal partially-optimal operating parameter value 316 is a parameter value that is associated with a particularly desirable set of KPIs 302. In another embodiment of the present invention, optimal partially-optimal operating parameter value 316 is a parameter value that occurs particularly often in operational data 112, indicating that optimal partially-optimal operating parameter value 316 is particularly easy to achieve and maintain in the industrial process.

At a next step 322, at least one partially-optimal SOP 294, of the one or more partially-optimal SOPs 294 generated at step 288, is preferably implemented in the industrial process. It is appreciated that as used herein, “implementing” a particular SOP is used to mean changing an SOP of the industrial process to match the particular SOP that is being implemented, and preferably to run the industrial process or a sub-process of the industrial process using the particular SOP one or more times.

In one embodiment of the present invention, the implementation of the at least one partially-optimal SOP 294 is a manual implementation. In another embodiment of the present invention, the implementation of the at least one partially-optimal SOP 294 is an automated implementation. In yet another embodiment of the present invention, the implementation of the at least one partially-optimal SOP 294 is a partially manual and partially automated implementation.

Preferably, in a case wherein at least one optimal partially-optimal operating parameter value 316 is provided for at least one of partially-optimal OPVRs 296 at step 312, optimal partially-optimal operating parameter value 316 is employed in implementing partially-optimal OPVRs 296 of the at least one partially-optimal SOP 294 at step 322. For example, for a type of operating parameter 118 that represents a machine setpoint, the machine setpoint is preferably set to optimal partially-optimal operating parameter value 316.

At a next step 324, a decision is made whether or not to provide any additional partially-optimal OPVRs 296. If any additional partially-optimal OPVRs 296 are to be provided, for example if a previously provided partially-optimal SOP 294 includes an undesirably large number of partially-optimal OPVRs 296 that are substantially identical with ones of the historical multiple-SOP OPVRs, the method returns to step 288, at which at least one additional partially-optimal SOP 294 is provided. Preferably, the additional partially-optimal SOP 294 has fewer partially-optimal OPVRs 296 that are substantially identical with ones of the historical multiple-SOP OPVRs and more partially-optimal OPVRs 296 that are substantially identical with ones of optimal OPVRs 256 than the partially-optimal SOP 294 provided during a previous execution of step 288.

If no additional partially-optimal OPVRs 296 are to be provided, the method proceeds to an optional next step 330, at which optimal OPVRs 256 of at least one of optimal SOPs 254 selected at step 228 is preferably implemented in the industrial process. It is appreciated that as used herein, “implementing” a particular SOP is used to mean changing an SOP of the industrial process to match the particular SOP that is being implemented, and preferably to run the industrial process or a sub-process of the industrial process using the particular SOP one or more times.

In one embodiment of the present invention, the implementation of optimal SOP 254 is a manual implementation. In another embodiment of the present invention, the implementation of optimal SOP 254 is an automated implementation. In yet another embodiment of the present invention, the implementation of optimal SOP 254 is a partially manual and partially automated implementation.

Preferably, in a case wherein at least one optimal operating parameter value 286 is provided for at least one of optimal OPVRs 256 at step 282, optimal operating parameter value 286 is employed in implementing optimal OPVRs 256 of optimal SOP 254 at step 330. For example, for a type of operating parameter 118 that represents a machine setpoint, the machine setpoint is preferably set to optimal operating parameter value 286.

Preferably, in an embodiment in which KPI weighting ranges 272 are provided at sub-step 270, before implementing optimal OPVRs 256 of optimal SOP 254 at step 330, the method ascertains that the set of KPI weighting ranges 272 associated with optimal SOP 254 is desirable for the industrial process.

For example, consider a case wherein KPI weighting coefficients 128 have changed from the KPI weighting coefficients 128 provided at step 110, and the updated KPI weighting coefficients 128 do not fall within the KPI weighting ranges 272 for the optimal SOP 254 provided at sub-step 248 of step 228. In that case, the optimal SOP 254 implemented in the industrial process at step 330 is preferably an additional optimal SOP 254 provided sub-step 248 of step 228, the additional optimal SOP 254 being associated with an additional set of KPI weighting ranges 272, provided at sub-step 270, where the updated KPI weighting coefficients 128 fall within the additional KPI weighting ranges 272.

Preferably, in addition to or in lieu of implementing the at least one partially-optimal SOPs 294 at step 288 and optimal SOPs 254 at step 330, the method additionally or alternatively identifies and displays partially-optimal SOPs 294 and/or optimal SOPs 254 to a user, for example by providing a digital readout or printed readout of partially-optimal SOPs 294 and/or optimal SOPs 254.

It is appreciated that the method of FIG. 1A may be run any suitable number of times, for example, upon collection of additional operational data suitable to be provided at step 110.

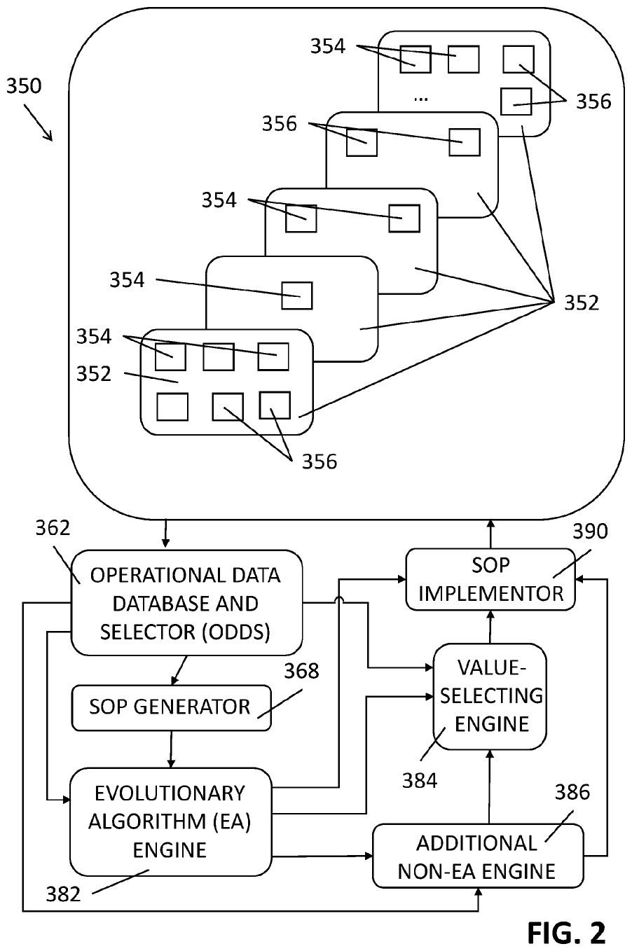

Reference is now made to FIG. 2, which is a simplified schematic illustration of a system 350 for implementing an optimal set of operating parameters (SOP) in an industrial process, which involves operation of at least one machine 352, useful in performing the methods of FIG. 1A.

As seen in FIG. 2, system 350 preferably forms part an industrial process involving an operation of at least one machine 352, including either a single machine 352, such as a motor or transformer, or multiple machines 352, such as a mining process or a manufacturing process.

At least one of machines 352 preferably includes at least one sensor 354. Additionally, at least one of machines 352 preferably includes at least one actuator or controller 356. In one embodiment of the present invention, at least one of machines 352 includes both of at least one sensor 354 and at least one actuator or controller 356.

In a preferred embodiment of the present invention, system 350 includes an Operational Data Database and Selector (ODDS) 362 which preferably receives and provides at least one set of operational data, such as operational data 112, including a plurality of historical SOPs and a plurality of historical sets of KPIs, such as historical SOPs 114 and historical sets of KPIs 116.

ODDS 362 preferably receives at least some of the historical SOPs from some of sensors 354. Additionally, ODDS 362 preferably receives at least some of the historical sets of KPIs from some of sensors 354. Additionally or alternatively, some of the data supplied to ODDS 362 are provided by records of actionable values set by users (e.g., a target oven temperature set by an operator). ODDS 362 preferably performs step 110 of the method of FIG. 1A.

Preferably, in addition to receiving and storing historical operating data, ODDS 362 is also operative to select a sub-set of the operating data, particularly a sub-set of the historical SOPs, to form at least part of an initial population of SOPs. As described hereinabove with reference to sub-step 230 of the method of FIG. 1A, the initial population may be a random initial population or a non-random initial population.

Preferably, system 350 preferably optionally includes an SOP generator 368 which preferably receives the operational data from ODDS 362 and employs the operational data to generate at least one additional SOP, such as the at least one additional SOP generated at step 210 of the method of FIG. 1A.

Preferably, system 350 preferably additionally includes an evolutionary algorithm (EA) engine 382, which preferably receives operational data from ODDS 362 and, optionally, the additional SOP or SOPs from SOP generator 368. EA engine 382 preferably applies an EA to the operational data, and, optionally, the additional SOP as well, thereby identifying at least one optimal SOP, such as optimal SOP 254, including types of operating parameters, such as types of operating parameters 118, and optimal operating parameter value ranges (OPVRs), such as optimal OPVRs 256. EA engine 382 preferably performs step 228 of the method of FIG. 1A.

In a preferred embodiment of the present invention, system 350 further includes an optional value-selecting engine 384 for providing at least one optimal operating parameter value, such as optimal operating parameter value 286 for at least one of the optimal OPVRs, as described with reference to step 282 of the method of FIG. 1A. Value-selecting engine 384 preferably generates the optimal operating parameter value or values at least partially based on the optimal SOPs, received from EA engine 382. In a preferred embodiment of the present invention, value-selecting engine 384 preferably also employs data provided by ODDS 362 to generate the optimal operating parameter value or values.

In a preferred embodiment of the present invention, system 350 further includes an optional additional non-EA engine 386 for providing one or more partially-optimal SOPs, such as partially-optimal SOPs 294, as described with particular reference to step 288 of the method of FIG. 1A. As described hereinabove, the partially-optimal SOPs preferably include types of operating parameters, such as types of operating parameters 118, and partially-optimal OPVRs, such as partially-optimal OPVRs 296. Preferably, additional non-EA engine 386 employs both the historical SOPs, provided by ODDS 362, and the optimal SOPs, provided by EA engine 382, to generate the partially-optimal SOP or SOPs.

Preferably, value-selecting engine 384 additionally provides at least one optimal partially-optimal operating parameter value, such as optimal partially-optimal operating parameter value 286, for the partially-optimal OPVRs, as described with reference to step 312 of the method of FIG. 1A. Value-selecting engine 384 preferably generates the optimal partially-optimal operating parameter value or values at least partially based on the partially-optimal SOPs, received from additional non-EA engine 386. In a preferred embodiment of the present invention, value-selecting engine 384 preferably also employs data provided by ODDS 362 to generate the optimal partially-optimal operating parameter value or values.

Preferably, system 350 further optionally includes an SOP implementor 390 for implementing the partially-optimal SOPs, provided by additional non-EA engine 386, and/or the optimal SOPs, provided by EA engine 382, in the industrial process, as described in respective steps 322 and 330 of the method of FIG. 1A.

As described hereinabove, the implementation of the partially-optimal SOPs and optimal SOPs may be a manual implementation, an automated implementation, or an implementation that is partially manual and partially automated. In a preferred embodiment of the present invention, the automatic implementation of the partially-optimal SOPs and optimal SOPs is facilitated by either direct or indirect communication between SOP implementor 390 and some or all of actuators or controllers 356.

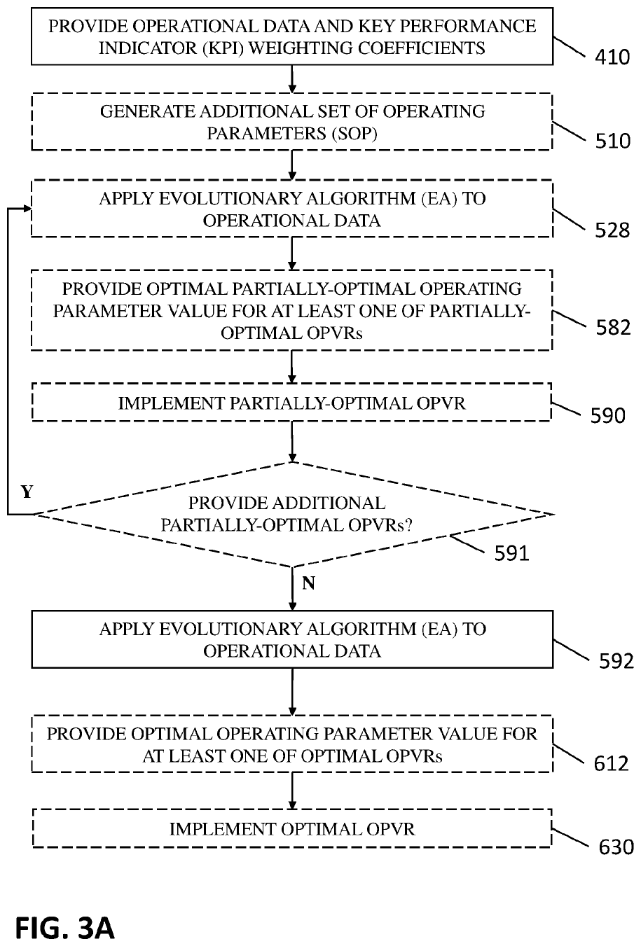

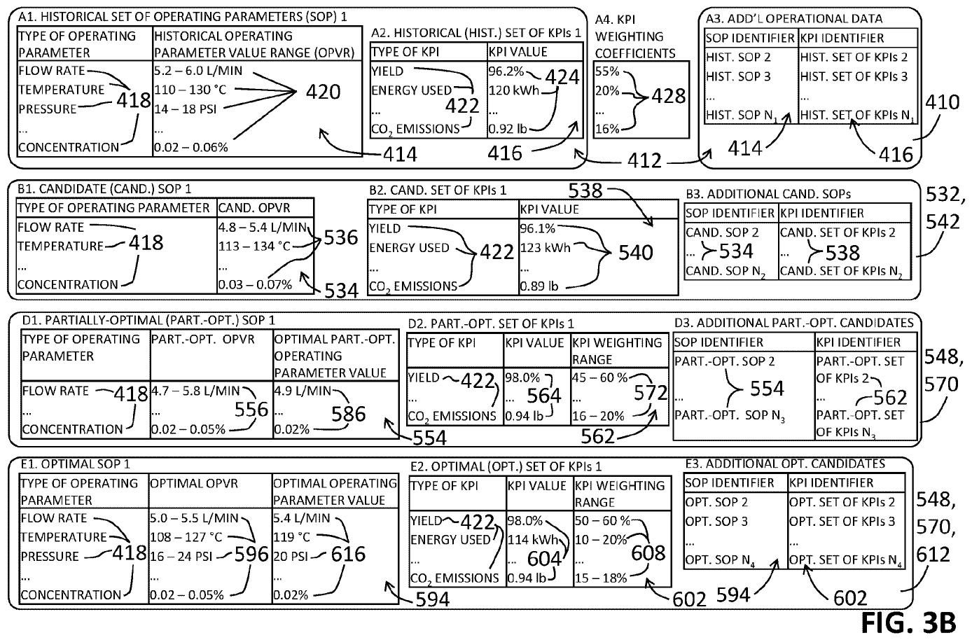

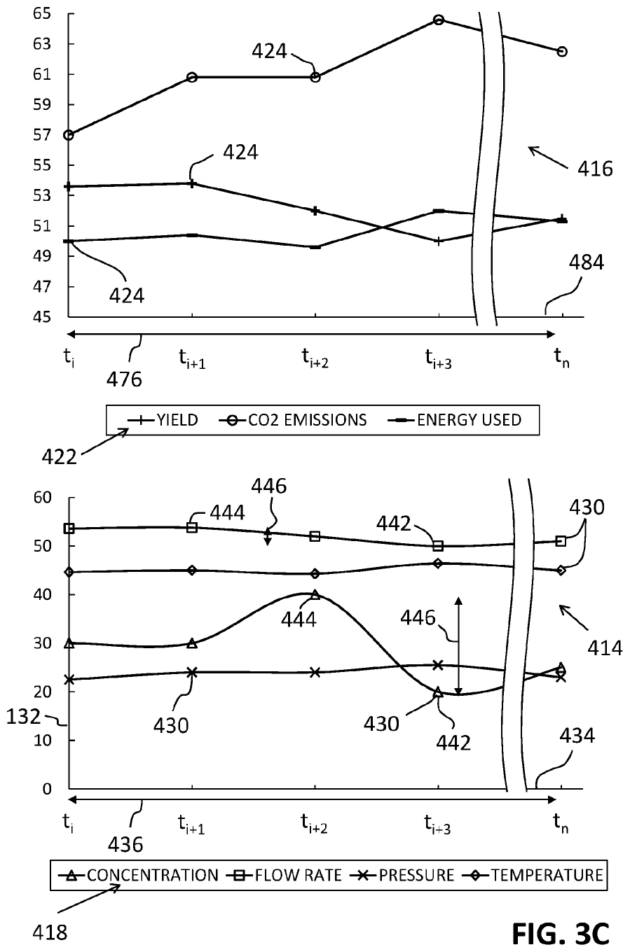

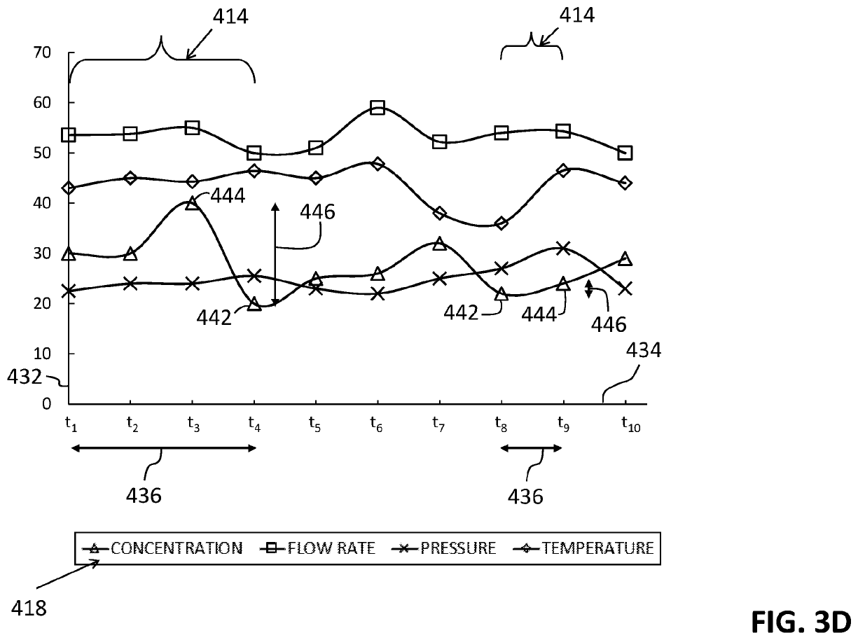

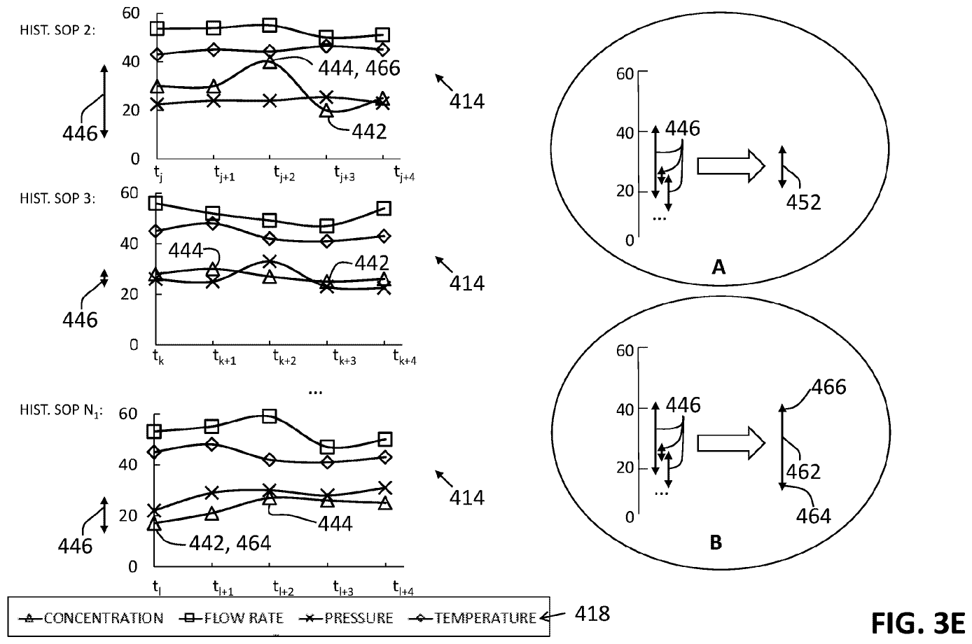

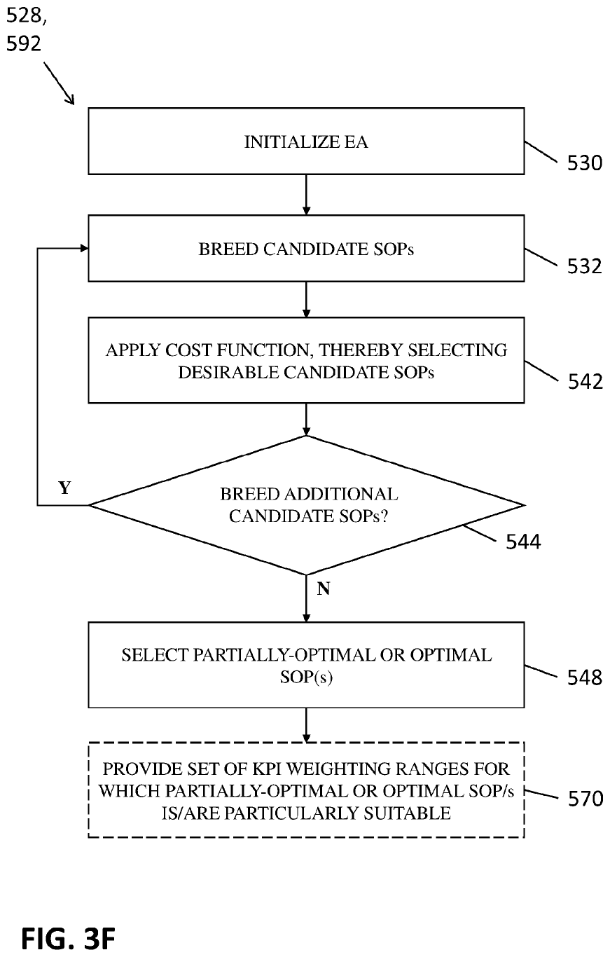

Reference is now made to FIG. 3A, which is a simplified flow chart illustrating a method for implementing an optimal SOP in an industrial process involving operation of at least one machine, in accordance with another preferred embodiment of the present invention, FIG. 3B, which is a simplified representation of exemplary data used in selected steps of the method of FIG. 3A, FIG. 3C, which is a simplified plot illustrating exemplary data used in selected steps of the method of FIG. 3A, FIG. 3D, which is a simplified plot illustrating additional exemplary data used in selected steps of the method of FIG. 3A, FIG. 3E, which is a simplified plot illustrating yet additional exemplary data used in selected steps of the method of FIG. 3A, and FIG. 3F, which is a simplified flowchart illustrating a portion of the method of FIG. 3. In FIGS. 3A and 3F, steps outlined in dashed lines are optional. If any optional steps are not performed, the method preferably continues to the next step.

It is appreciated that the method of FIG. 3A is similar to the method of FIG. 1A, in that in a preferred embodiment of the present invention, both methods preferably identify both optimal SOPs and partially-optimal SOPs. However, the method of FIG. 3A differs from the method of FIG. 1A particularly in the type of partially-optimal SOPs that are provided.

As described hereinabove, partially-optimal SOPs 294 of the method of FIG. 1A include partially-optimal OPVRs 296, of which some are substantially identical with ones of the historical multiple-SOP OPVRs and some are substantially identical with ones of partially-optimal OPVRs 296. In contrast, as described in more detail hereinbelow, in the method of FIG. 3A, partially-optimal SOPs include partially-optimal OPVRs having OPVR spreads which are narrower than historical multiple-SOP OPVR spreads, but wider than optimal OPVR spreads. Unlike in the method of FIG. 1A, typically, in the method of FIG. 3A, many or all of the partially-optimal OPVRs are changed for each different partially-optimal SOPs.

As seen in FIGS. 3A & 3B, at a first step 410, a collection of operational data 412 is provided. As seen particularly in FIGS. 3B & 3C, operational data 412 preferably includes a multiplicity of historical SOPs 414, and a multiplicity of historical sets of Key Performance Indicators (KPIs) 416, each of the historical sets of KPIs 416 corresponding to one of the historical SOPs 414.

Historical SOPs 414 relate to operating parameters that have been used in previous runs of by the industrial process, prior to step 410 of the method of FIG. 3A. It is appreciated that operational data 412 can span any suitable time range, the time range being either contiguous or non-contiguous. For example, the time range spanned by operational data 412 may be, inter alia, an entirety of a previous decade, an entirety of a previous year, an entirety of a previous financial quarter, an entirety of a previous month, or an entirety of a previous week. Similarly, the time range spanned by operational data 412 may be, inter alia, a previous decade excluding downtime of the industrial process, a previous year excluding downtime of the industrial process, a previous financial quarter excluding downtime of the industrial process, a previous month excluding downtime of the industrial process, or a previous week excluding downtime of the industrial process. Additionally, the time range spanned by operational data 412 may be, inter alia, a previous decade excluding time periods associated with unusually undesirable KPIs 416, a previous year excluding time periods associated with unusually undesirable KPIs 416, a previous financial quarter excluding time periods associated with unusually undesirable KPIs 416, a previous month excluding time periods associated with unusually undesirable KPIs 416, or a previous week excluding time periods associated with unusually undesirable KPIs 416.

Each of historical SOPs 414 typically includes a plurality of types of operating parameters 418 and a plurality of historical operating parameter value ranges (OPVRs) 420, which together describe at least some aspects of the industrial process. As seen particularly in Table A1 of FIG. 3B, each of historical OPVRs 420 corresponds to one of the types of operating parameters 418. In a preferred embodiment of the present invention, each of historical SOPs 414 includes an identical plurality of types of operating parameters 418. In another embodiment of the present invention, some of plurality of types of operating parameters 418 present in some of historical SOPs 414 may be omitted, or may be present without having any corresponding OPVRs 420, in others of historical SOPs 414.

For example, as seen in Table A1 of FIG. 3B, one of historical SOPs 414, Historical SOP 1, includes, inter alia, types of operating parameter 418 of flow rate, temperature, pressure and concentration, having corresponding historical OPVRs 420 of 5.2-6.0 L/min, 110-130° C., 14-18 PSI and 0.02-0.06 w/w %, respectively. It is appreciated that each of types of operating parameters 418 includes more detail than is described herein, for example, a machine or portion of machine with which the type of operating parameter 418 is associated and/or a material type with which the type of operating parameter 418 is associated. Additionally, each historical SOP 414 typically includes many types of operating parameters 418, such as more than 3 types of operating parameters, more than 5 types of operating parameters, more than 10 types of operating parameters, more than 20 types of operating parameters, more than 30 types of operating parameters, more than 50 types of operating parameters, more than 100 types of operating parameters, more than 200 types of operating parameters and more than 500 types of operating parameters. Furthermore, in some embodiments of the present invention, some of types of operating parameters 418 have a unit of measurement which is the same as a unit of measurement as at least one other of types of operating parameters 418. Additionally or alternatively, some types of operating parameters 418 may indicate environmental attributes associated with the industrial process, a type of product being produced or used by the industrial process, machines used by the industrial process, or the like.

For example, a historical SOP 414 for a plant floor employing multiple belt furnaces may include types of operation parameters such as, inter alia, a first furnace identifier, a second furnace identifier, a first furnace first zone temperature, a first furnace second zone temperature, a first furnace third zone temperature, a second furnace first zone temperature, a second furnace second zone temperature, a second furnace third zone temperature, a first furnace linear belt speed, a second furnace linear belt speed, a first furnace first zone vibration frequency, a first furnace second zone vibration frequency, a second furnace first zone vibration frequency, a second furnace second zone vibration frequency, a cooling region temperature, a first furnace nitrogen flow rate, a second furnace nitrogen flow rate, a first furnace CO₂ flow rate, a second furnace CO₂ flow rate, a nitrogen purity grade, a cooling region nitrogen flow rate, a cooling region ambient air flow rate, a first fan rotational rate, a second fan rotational rate, a third fan rotational rate, a fourth fan rotational rate, a fifth fan rotational rate, at least one plant floor ambient humidity percentage, and a plant floor concentration of particles in air.

In a preferred embodiment of the present invention, some historical OPVRs 420 are provided by measured values output by sensors (e.g., an oven temperature measured by a thermocouple). It is appreciated that historical OPVRs 420 may be raw sensor output or data extracted from sensor output, such as, inter alia, an average or standard deviation of raw sensor output. Additionally or alternatively, some historical OPVRs 420 are provided by records of actionable values set by users (e.g., a target oven temperature set by an operator).

As described hereinabove and as seen particularly in step 410 of FIG. 3B, each historical SOP 414 is associated with a corresponding one of historical sets of KPIs 416. Each historical set of KPIs 416 typically includes plurality of types of KPIs 422 and a plurality of historical KPI values 424, which together quantify a desirability of the historical SOP 414 with which the historical set of KPIs 416 is associated. As seen particularly in Table A2 of FIG. 3B, each of historical KPI values 424 corresponds to one of the types of KPIs 422.

For example, as seen in Table A2 of FIG. 3B, one of historical sets of KPIs 416, Historical Set of KPIs 1, includes, inter alia, types of KPIs 422 of yield, energy used and CO₂ emissions, having corresponding historical KPI values 424 of 96.2%, 120 kWh and 0.92 lb., respectively.

In one embodiment of the present invention, each of types of KPIs 422 of historical set of KPIs 416 relates particularly to that portion of the industrial process to which the corresponding historical SOP 414 relates. For example, if a historical SOP 414 relates particularly to a belt-furnace and subsequent cooling portion of a larger industrial process, corresponding historical set of KPIs 416 may relate to, inter alia, the yield of, energy used by and CO₂ emissions produced by the belt furnace and subsequent cooling portion of the larger industrial process, while not relating to yield, energy use or emissions of other portions of the industrial process.

In another embodiment of the present invention, each of types of KPIs 422 of historical set of KPIs 416 relates to more than just the portion of the industrial process to which the corresponding historical SOP 414 relates, for example the entirety of the industrial process. For example, if a historical SOP 414 relates particularly to a belt-furnace and subsequent cooling portion of a larger industrial process, corresponding historical set of KPIs 416 may relate to, inter alia, the yield of, energy used by and CO₂ emissions produced by an entirety of that portion of the industrial process performed in the same city in which the belt furnace and subsequent cooling portion of the larger industrial process is performed.

In a preferred embodiment of the present invention, some historical KPI values 424 are provided by measured values output by sensors (e.g., an amount of CO₂ emissions as measured by flow sensors in an exhaust chimney and an oven temperature measured by a thermocouple). It is appreciated that historical KPI values 424 may be raw sensor output or data extracted from sensor output, such as, inter alia, an average or standard deviation of raw sensor output. Additionally or alternatively, some historical KPI values 424 are provided by records maintained by human users (e.g., a production yield manually recorded by a shift manager).

It is appreciated that various ones of types of KPIs 422 in historical set of KPIs 416 may be mutually competing KPIs, and as a value of one of the mutually competing KPIs improves, a value of at least one of the other of the mutually competing KPIs worsens. For example, historical sets of KPIs 416 may include types of KPIs including KPIs which are indicative of, inter alia, a monetary manufacturing cost and a quality of a finished product. In such a case, as the monetary manufacturing cost declines, finished product quality may decrease.

Additionally, different ones of types of KPIs 422 may have a higher relative importance to the industrial process than other ones of types of KPIs 422, and the relative importance of different ones of types of KPIs 422 may change based on various circumstances. Therefore, along with operational data 412, a set of KPI weighting coefficients 428 corresponding to types of KPIs 422 is preferably provided at step 410. KPI weighting coefficients 428 offer a numeric indication of a relative importance of various ones of types of KPIs 422. Preferably, each of types of KPIs 422 is associated with a particular KPI weighting coefficient 428, and together, all of the KPI weighting coefficients 428 add up to 100%.

It is appreciated that KPI weighting coefficients 428 support trade-off management in assessing which of historical SOPs 414 are associated with a particularly desirable historical set of KPIs 416, by quantifying which of types of KPIs 422 in each historical set of KPIs 416 are relatively more important than others of types of KPIs 422 in each historical set of KPIs 416. In one embodiment of the present invention, values of KPI weighting coefficients 428 are selected by a human operator, such as a plant manager. In another embodiment of the present invention, values of KPI weighting coefficients 428 are selected by a fully or partially automated process. Typically, values of KPI weighting coefficients 428 may be changed depending on various circumstances and considerations.

As described hereinabove and as seen particularly in Table A3, each of multiplicity of historical SOPs 414 of operational data 412 is associated with a corresponding historical set of KPIs 416. Thus, for example, historical SOP 1 is associated with historical set of KPIs 1, historical SOP 2 is associated with historical set of KPIs 2, and historical SOP N₁ is associated with historical set of KPIs N₁.

Reference is now made particularly to FIG. 3C, which shows an association of an exemplary historical SOP 414 with a corresponding historical set of KPIs 416. For illustrative purposes, FIG. 3C corresponds to Historical SOP 1 of Table A1 of FIG. 3B, and each type of operating parameter 418 and associated historical OPVR 420 is represented by data points having a particular shape. Thus, in FIG. 3C, square-shaped data points represent flow rate, diamond-shaped data points represent temperature, triangular-shaped data points represent concentration and x-shaped data points represent pressure. For ease of representation, FIG. 3C has been greatly simplified, and the data has been normalized and is shown with arbitrary normalized units.

It is seen that each historical SOP 414 includes multiple types of operating parameters 418, each of which includes a multiplicity of operating parameter values 430, as indicated by a position of operating parameter value 430 relative to a vertical axis 432. Each of the operating parameter values 430 is associated with a different time, as indicated by a position of operating parameter value 430 relative to a horizontal axis 434.

It is appreciated that each of the times shown on horizontal axis 434 indicates a unique date and time combination prior, to step 410 of the method of FIG. 3A. The intervals between various ones of operating parameter values 430 may be any suitable intervals of time, such as, inter alia, seconds, minutes, shifts, days, weeks, months, quarters or years.

Additionally, each historical SOP 414 relates to an SOP-time interval 436, which is a difference between a first time t₁ associated with an operating parameter value 430 of the historical SOP 414 and a last time tₓ, such as, inter alia, tᵢ₊₁, tᵢ₊₂, tᵢ₊₃ or tᵢ₊₇, associated with an operating parameter value 430 of the historical SOP 414. The SOP-time interval 436 for each historical SOP 414 in operational data 412 is preferably identical or nearly identical to the SOP-time interval 436 of every other historical SOP 414 in operational data 412. SOP-time intervals 436 may have values of any suitable intervals of time, such as, inter alia, seconds, minutes, shifts, days, weeks, months, quarters or years. In a preferred embodiment of the present invention, SOP-time intervals 436 have values that are not arbitrary, but that indicate units of time that are particularly relevant to the industrial process, such as, inter alia, shifts, days, work-weeks, months, financial quarters or yearly seasons. It is appreciated that the SOPs 114 shown in FIGS. 4C, 4D and 4E do not span an entirety of the time range spanned by operational data 412.

Preferably, SOP-time intervals 436, when added together, are substantially equal to the time range spanned by operational data 412. Thus, for example, if operational data 412 spans a time range equal to one standard year, and each of SOP-time intervals 436 has a value of one day, there are preferably 365 SOP-time intervals 436, which together add up to the year spanned by operational data 412.

Thus, each historical SOP 414 typically includes multiple operating parameter values 430. For each type of operating parameter 418, operation parameter values 430 associated with a single historical SOP 414 together define OPVR 420, which is also referred to herein as a historical single-SOP OPVR 420.

As seen particularly in FIGS. 3C & 3D, for each type of operating parameter 418, for each SOP-time interval 436, at least one of operating parameter values 430 of each historical OPVR 420 is a historical minimum parameter value 442 and at least one at least one of operating parameter values 430 of each historical OPVR 420 is a historical maximum parameter value 444. A difference between historical maximum parameter value 444 and historical minimum parameter value 442 defines a historical OPVR spread 446 for each type of operating parameter 418. As is readily apparent, a value of OPVR spread 446 is dependent on a choice of SOP-time intervals 436.

For example, as seen particularly in FIG. 3D, if SOP-time interval 436 extends from t₁ to t₄ on horizontal axis 434, the CONCENTRATION operating parameter 418 of the SOP 414 shown in FIG. 3D is characterized by a historical minimum parameter value 442 of approximately 18 normalized units of vertical axis 432 and a historical maximum parameter value 444 of approximately 40 normalized units of vertical axis 432. Thus, historical OPVR spread 446 of the CONCENTRATION operating parameter 418 of the SOP 414 is characterized by a value of approximately 22 arbitrary units of vertical axis 432.

However, if SOP-time interval 436 extends from t₈ to t₉ on horizontal axis 434, the CONCENTRATION operating parameter 418 of the SOP 414 shown in FIG. 3D is characterized by a historical minimum parameter value 442 of approximately 21 normalized units of vertical axis 432 and a historical maximum parameter value 444 of approximately 23 normalized units of vertical axis 432. Thus, historical OPVR spread 446 of the CONCENTRATION operating parameter 418 of the SOP 414 is characterized by a value of approximately 2 arbitrary units of vertical axis 432.

As seen particularly in FIG. 3E, which shows selected, simplified data from selected, simplified SOPs 414 of operational data 412, for each type of operating parameter 418, the values of historical OPVR spreads 446 of various ones of historical SOPs 414 of operational data 412 typically differ from that the values of corresponding historical OPVR spreads 446 of other ones of historical SOPs 414 of operational data 412.

In a preferred embodiment of the present invention, for operational data 412, a single average historical OPVR spread 452 is defined for each of the types of operating parameters 418. Preferably, for each of the types of operating parameters 418, the average historical OPVR spread 452 is an average of the historical OPVR spreads 446 of that type of operating parameter 418 of some or all historical SOPs 414 of operational data 412. It is appreciated that a value of average historical OPVR spread 452 is dependent on a size of SOP-time interval 436.

For example, oval A of FIG. 3E shows historical OPVR spreads 446 for the CONCENTRATION operating parameter 418 of the SOPs 414 shown in FIG. 3E. It is noted that ellipses in FIG. 3E denote other SOPs 414 or OPVR spreads 446 in operational data 412, which, for simplicity, are not shown in FIG. 3E. As seen in oval A of FIG. 3E, average historical OPVR spread 452 for the CONCENTRATION operating parameter 418 is an average of the historical OPVR spreads 446 for the CONCENTRATION operating parameter 418 within operational data 412.

The single average historical OPVR spread 452 may be calculated based on any suitable type of average, including, inter alia, a mean, mode or median. Similarly, the average may be a weighted average, in which each of the historical SOPs 414 and its associated historical OPVR spread 446 is characterized by a weighting coefficient, and the weighting coefficient is used in calculating the average historical OPVR spread 452. The weighting coefficient may be any suitable weighting coefficient.

In a first example, the weighting coefficient of each of the historical SOPs 414 and its associated historical OPVR spread 446 may be a quantitative indication of a recency of each historical SOP 414. In such a case, for example, historical OPVR spreads 446 of relatively recent historical SOPs 414 may be given a higher weighting coefficient than historical OPVR spreads 446 of historical SOPs 414 from further in the past.

In a second example, the weighting coefficient of each of the historical SOPs 414 and its associated historical OPVR spread 446 may be related to the historical set of KPIs 416 with which the historical SOP 414 is associated. In such a case, for example, historical OPVR spreads 446 of historical SOPs 414 associated with relatively desirable historical sets of KPIs 416 may be given higher weighting coefficients than historical OPVR spreads 446 of historical SOPs 414 associated with relatively undesirable historical sets of KPIs 416.

In addition to the average historical OPVR spread 452, one or more historical multiple-SOP OPVRs, each having a historical multiple-SOP OPVR spread 462, may also be defined. Preferably, one multiple-SOP OPVR is defined for each of the types of operating parameters 418. In a preferred embodiment of the present invention, each of the multiple-SOP OPVRs is formed from a multiplicity of historical single-SOP OPVRs 420.

More specifically, for each of the types of operating parameters 418, the corresponding historical multiple-SOP OPVR is preferably an OPVR extending from a historical multiple-SOP minimum parameter value 464, which is the lowest of historical minimum parameter values 442 of the multiplicity of historical single-SOP OPVR 420, to a historical multiple-SOP maximum parameter value 466, which is the highest historical maximum parameter value 444 of the multiplicity of historical single-SOP OPVR 420. Historical multiple-SOP minimum parameter value 464 and historical multiple-SOP maximum parameter value 466 are separated by historical multiple-SOP OPVR spread 462.

For example, oval B of FIG. 3E shows historical OPVR spreads 446 for the CONCENTRATION operating parameter 418 of the SOPs 414 shown in FIG. 3E. As described hereinabove, ellipses in FIG. 3E denote other SOPs 414 or OPVR spreads 446 in operational data 412, which, for simplicity, are not shown in FIG. 3E. As seen in oval B of FIG. 3E, historical multiple-SOP OPVR spread 462 for the CONCENTRATION operating parameter 418 extends from historical multiple-SOP minimum parameter value 464 for the CONCENTRATION operating parameter 418 to historical multiple-SOP maximum parameter value 466 for the CONCENTRATION operating parameter 418.

Together, types of operating parameters 418 and the historical multiple-SOP OPVRs form a historical combined SOP. In one embodiment of the present invention, operational data 412 includes a single historical combined SOP. In another embodiment of the present invention, operational data 412 includes two or more historical combined SOPs. If operational data 412 includes two or more historical combined SOPs, each historical combined SOPs is preferably formed from a different multiplicity of historical single-SOP OPVR 420.

As discussed hereinabove with particular reference to FIG. 3B, each historical SOP 414 is associated with a corresponding historical set of KPIs 416. Returning now to FIG. 3C, it is seen that a KPI-time interval 476 corresponds to SOP-time interval 436. Within KPI-time interval 476, historical set of KPIs 416 preferably includes at least one historical KPI value 424 for each type of KPIs 422. For ease, in the embodiment shown in simplified FIG. 3C, positions of historical KPI values 424 relative to a horizontal axis 484 are identical or nearly identical to positions of corresponding operating parameter values 430 relative to horizontal axis 434, indicating that KPI values 424 and corresponding operating parameter values 430 were sampled at identical or nearly identical times.

However, in another embodiment of the present invention, KPI values 424 and corresponding operating parameter values 430 are not sampled at identical or nearly identical times. KPI values 424 and corresponding operating parameter values 430 may be sampled at any suitable sampling times with any suitable sampling rates. It is highly preferable, however, that for each corresponding pair of historical SOP 414 and historical set of KPIs 416, SOP-time interval 436 is substantially identical to KPI-time interval 476.

In a preferred embodiment of the present invention, a shared timestamp or timestamps, indicated by an identical or nearly identical position of operating parameter values 430 relative to horizontal axis 434, causes various ones of single-SOP OPVRs 420 corresponding to various ones of types of operating parameters 418 to be collected into a single SOP 414. Similarly, a shared timestamp or timestamps, indicated by an identical or nearly identical position of various KPI values 424 relative to horizontal axis 434, causes various KPI values 424 corresponding to various ones of types of KPIs 422 to be collected into a single set of KPIs 416. Additionally, the shared timestamp or timestamps causes an SOP 414 to be associated with a corresponding one of sets of KPIs 416.

It is appreciated that as part of or prior to step 410, operational data 412 is preferably cleaned in a pre-processing step. The cleaning and pre-processing of operational data 412 preferably includes traceability operations, in which KPI values 424 and corresponding operating parameter values 430 are moved along axes 484 and 434, respectively, to synchronize operational data 412. Additionally, during cleaning and pre-processing, operational data 412 is examined for outlying data points, and data determined to be, for example, unreliable or irrelevant is either removed or replaced.

Turning once more to FIG. 3A, at an optional next step 510, at least one additional SOP is generated from operational data 412. The at least one additional SOP generated at step 510 includes the plurality of types of operating parameters 418 which is included in historical SOPs 414 of operational data 412, as well as a plurality of additional OPVRs. Each of the plurality of additional OPVRs preferably corresponds to a particularly desirable one of historical sets of KPIs 416.

In a preferred embodiment of the present invention, in order to identify historical OPVRs 420 which are associated with particularly desirable historical sets of KPIs 416 for a particular type of operating parameters 418, a one-dimensional optimization is performed as part of step 510. The one-dimensional optimization of step 510 evaluates each type of operating parameter 418 independently of the others of types of operating parameter 418.

As part of the one-dimensional optimization of step 510, for each type of operating parameter 418, the corresponding one of multiple-SOP OPVR is divided into sub-OPVRs. The multiple-SOP OPVR may be divided into any suitable number of sub-OPVRs, for example, 2, 3, 4, 5 or 6 OPVRs. In one embodiment of the present invention, each of the multiple-SOP OPVRs is divided into sub-OPVRs each having a time interval of substantially the same size as time intervals of others of sub-OPVRs. In another embodiment of the present invention, each of the multiple-SOP OPVRs is divided sub-OPVRs each having a time interval not of substantially the same size as time intervals of others of sub-OPVRs. Once the multiple-SOP OPVRs have been divided into sub-OPVRs, the one-dimensional optimization of step 510 identifies and selects the sub-OPVR which is associated with a more desirable set of KPIs than the others of the sub-OPVRs.

Preferably, the one-dimensional optimization of step 510 is performed separately for each of types of operating parameters 418, thereby generating the at least one additional SOP. It is appreciated that the additional SOP may be an SOP that is either possible to implement or impossible to implement. For example, the additional OPVRs of the additional SOP may, when taken together, violate physical laws. For example, the additional SOP may include a temperature range for a gas and a pressure range for the gas that together violate the ideal gas law of pV=nRT, where P is a pressure of a gas, V is a volume of the gas, n is an amount of the gas, typically in moles, R is the molar gas constant, and T is a temperature of the gas.

Thereafter, at a next step 528, an evolutionary algorithm (EA) is applied to operational data 412, thereby identifying a partially-optimal SOP. Preferably, in a case wherein the method includes step 510, the EA is also applied to at least one of the additional SOPs generated at step 510. The EA of step 528 may be any suitable EA, for example, a GA, an EA similar to, inter alia, the EAs disclosed in any of Deb, K., Pratap, A., Agarwal, S. and Meyarivan, T. A. M. T., 2002. A fast and elitist multiobjective genetic algorithm: NSGA-II. IEEE transactions on evolutionary computation, 6(2), pp. 182-197; Deb, K. and Jain, H., 2013. An evolutionary many-objective optimization algorithm using reference-point-based nondominated sorting approach, part I: solving problems with box constraints. IEEE transactions on evolutionary computation, 18(4), pp. 577-601; and Jain, H. and Deb, K., 2013. An evolutionary many-objective optimization algorithm using reference-point based nondominated sorting approach, part II: Handling constraints and extending to an adaptive approach. IEEE Transactions on evolutionary computation, 18(4), pp. 602-622. In a preferred embodiment of the present invention, the EA of step 528 is a genetic algorithm.

Turning now particularly to FIG. 3F, which is a simplified flowchart illustrating sub-steps of step 528 of FIG. 3A, it is seen that at a first sub-step 530, the EA is initialized, or seeded with an initial population of SOPs. In other words, an initial population of SOPs is supplied to the EA at sub-step 530. Typically, the initial population of SOPs supplied to the EA at sub-step 530 includes at least a subset of historical SOPs 414. Any suitable initial population may be used at sub-step 530, such as a random initial population or a non-random initial population.

In a preferred embodiment of the present invention, the initial population of SOPs supplied at sub-step 530 is at least partially non-random, and at least some historical SOPs 414, in the subset of historical SOPs 414 included in the initial population of SOPs, are historical SOPs 414 which are associated with a particularly desirable historical set of KPIs 416, as at least partially determined by the KPI weighting coefficients 428 provided at step 410.

In an additional preferred embodiment of the present invention, the initial population of SOPs supplied at sub-step 530 is at least partially non-random, and includes at least one of the additional SOPs generated at step 510.

In yet another preferred embodiment of the present invention, the initial population of SOPs supplied at sub-step 530 is at least partially non-random, and includes both at least some historical SOPs 114 which are associated with particularly desirable historical set of KPIs 416, as determined by the KPI weighting coefficients 428 provided at step 410, and at least one of the additional SOPs generated at step 510.

At a next sub-step 532, the initial population of SOPs supplied at sub-step 530, which preferably includes at least some of operational data 412, and more preferably includes a subset of historical SOPs 414 and the at least one additional SOP generated at step 510, is employed in breeding a multiplicity of candidate SOPs 534.

As part of sub-step 532, members of the initial population supplied at sub-step 530 are selected, mated and mutated, thereby generating candidate SOPs 534. As seen particularly in Table B1 of FIG. 3B, each of candidate SOPs 534 includes plurality of types of operating parameters 418 and a plurality of candidate OPVRs 536, each of candidate OPVRs 536 corresponding to one of types of operating parameters 418. In an analogous manner to that of historical OPVRs 420, each of candidate OPVRs 536 preferably has a candidate minimum parameter value and a candidate maximum parameter value. A difference between the candidate minimum parameter value and the candidate maximum parameter value defines a candidate OPVR spread. Thus, the candidate minimum parameter value and the candidate maximum parameter value are separated by the candidate OPVR spread.

In a preferred embodiment of the present invention, a value of each of the candidate OPVR spreads associated with a type of operating parameter 418 is identical with or nearly identical with a value of average historical OPVR spread 452 of that type of operating parameter 418.

Additionally, each candidate SOP 534 is preferably associated with a candidate set of KPIs 538. Each candidate set of KPIs 538 typically includes plurality of types of KPIs 422 and a plurality of candidate KPI values 540, which together quantify a desirability of the candidate SOP 534 with which the candidate set of KPIs 538 is associated. As seen particularly in Table B2 of FIG. 3B, each of candidate KPI values 540 corresponds to one of the types of KPIs 422. It is appreciated that candidate sets of KPIs 538 are typically projected KPIs, and candidate KPI values 540 are typically estimated by the method of 3A-3F.

Returning now to FIG. 3F, at a next sub-step 542, a cost function is applied to candidate SOPs 534, thereby identifying a multiplicity of desirable candidate SOPs. Preferably, the cost function of sub-step 542 includes thresholding functionality. If at least some candidate OPVRs 536 of a candidate SOP 534 occur in less than a predetermined percentage of operational data 412, then that candidate SOP 534 is rejected by the thresholding functionality of the cost function.

In a preferred embodiment of the present invention, the value of the predetermined percentage of the thresholding functionality of the cost function of sub-step 542 is lowered each successive time that the EA of FIG. 3F is run. Thus, with each successive time that the EA of FIG. 3F is run, each of the candidate OPVRs 536 is required to appear in a smaller and smaller predetermined percentage of the overall operational data 412, thereby loosening a key parameter of the thresholding functionality.

The cost function of sub-step 542 proceeds to analyze each candidate SOP 534 that is not rejected by the thresholding functionality of the cost function. Preferably, in each iteration of sub-step 542, for each candidate SOP 534, the cost function of sub-step 542 analyzes operational data 412 to determine whether set of KPIs 538 associated with each of candidate SOPs 534 generated at an iteration of sub-step 532 immediately preceding that iteration of sub-step 542 is more or less desirable than sets of KPIs 238 associated with others of candidate SOPs 534 generated at the iteration of sub-step 532 immediately preceding that iteration of sub-step 542. In a preferred embodiment of the present invention, the desirability of historical sets of KPIs 416 is at least partially determined by the KPI weighting coefficients 428 provided at step 410.

In a preferred embodiment of the present invention, the cost function of sub-step 542 includes one or more of a Mann-Whitney Stochastic Order analysis, a period dominancy analysis and a recency weighting.

The Mann-Whitney Stochastic Order analysis used in the cost function of sub-step 542 may be any suitable Mann-Whitney Stochastic Order analysis, such as, inter alia, an analysis similar to that disclosed in H. B. Mann, D. R. Whitney “On a Test of Whether one of Two Random Variables is Stochastically Larger than the Other,” The Annals of Mathematical Statistics, Ann. Math. Statist. 18(1), 50-60, (March, 1947) and/or Nachar, Nadim. (2008). The Mann-Whitney U: A Test for Assessing Whether Two Independent Samples Come from the Same Distribution. Tutorials in Quantitative Methods for Psychology. 4. 10.20982/tqmp.04.1.p013.

The period dominancy analysis used in the cost function of sub-step 542 preferably evaluates a desirability of candidate SOPs 534 by evaluating each candidate SOP 534 for each of time intervals 436 in the time range spanned by operational data 412 separately. More specifically, each historical SOP 414 is split into two portions, which need not be contiguous. A first portion of historical SOP 414 is that portion of historical SOP 414 in which historical OPVRs 420 are within the bounds of candidate OPVRs 536. The first portion of historical SOP 414 has a first historical set of KPIs. A second portion of historical SOP 414 is that portion of historical SOP 414 in which the historical OPVRs 420 are outside of the bounds of candidate OPVRs 536. The second portion of historical SOP 414 has a second historical set of KPIs.

The period dominancy analysis of the cost function evaluates whether or not the first set of historical KPIs is more desirable than the second set of historical KPIs. It is appreciated that the evaluation may be performed using a Mann-Whitney Stochastic Order analysis, or any other suitable method. If the first historical set of KPIs is more desirable than the second historical set of KPIs, then the period dominancy analysis concludes that for the time interval 436 of that historical SOP 414, candidate SOP 534 is more desirable than other SOPs, and the cost function assigns that candidate SOP 534 a first value, such as 1, for the specific time interval 436 being evaluated. If, however, the first historical set of KPIs is less desirable than the second historical set of KPIs, then the period dominancy analysis concludes that for the time interval 436 being evaluated for that historical SOP 414, candidate SOP 534 is less desirable than other SOPs, and the cost function assigns that candidate SOP 534 a second value, such as 0, for that time interval 436.

The period dominancy analysis of the cost function repeats this process for each time interval 436 in the time range spanned by operational data 412, then assigns an overall score to that candidate SOP 534, based on the individual values for each time interval 436. The candidate SOPs 534 with the most desirable overall scores are identified as desirable candidate SOPs.

The recency weighting used in the cost function of sub-step 542 preferably assigns a higher weighting coefficient to portions of operation data 412 which are relatively recent than to portions of operational data 412 from further in the past. More specifically, the cost function of sub-step 542 preferably evaluates, for each candidate SOP 534, whether those portions of operational data 412 having historical OPVRs 420 within bounds of the candidate OPVRs 536 of that candidate SOP 534 are associated with KPIs which are more desirable than KPIs associated with those portions of operational data 412 having historical OPVRs 420 outside the bounds of the candidate OPVRs 536 of that candidate SOP 534. The cost function preferably assigns that candidate SOP 534 a first value, such as 1, for those portions of operational data 412 which indicate that candidate SOP 534 is a relatively desirable SOP, and a second value, such as 0, for those portions of operational data 412 which indicate that candidate SOP 534 is a relatively undesirable SOP. It is appreciated that the evaluation may be performed using a Mann-Whitney Stochastic Order analysis, or any other suitable method.

The recency weighting used in the cost function of sub-step 542 then modifies the values assigned to the candidate SOP 534. Typically, the recency weighting functionality of the cost function multiplies the values assigned to the candidate SOP 534 by a weighting coefficient. The weighting coefficients for recent portions of operational data 412 preferably have higher values than the weighting coefficients for less recent portions of operational data 412.

The recency weighting used in the cost function of sub-step 542 may be any suitable type of recency weighting. In a preferred embodiment of the present invention, the recency weighting includes an exponential decay function, in which more recent portions of operational data 412 are associated with weighting coefficients that are exponentially larger than those weighting coefficients associated with less recent portions of operational data 412. In another preferred embodiment of the present invention, the recency weighting includes another type of function, such as, inter alia, a linear function, a polynomial function, a root function, or a logarithmic function.

At a next sub-step 544, a decision is made whether or not to breed additional candidate SOPs 534. If additional candidate SOPs 534 are to be bred, the method returns to sub-step 532 and at least some of the desirable candidate SOPs identified at sub-step 542 are employed in breeding an additional multiplicity of candidate SOPs 534. As part of this iteration of sub-step 532, at least some of the desirable candidate SOPs identified at sub-step 542 are selected, mated and mutated, thereby generating additional candidate SOPs 534.

It is appreciated that the method can return from sub-step 544 to sub-step 532 any suitable number of times. For example, the method can return from sub-step 544 to sub-step 532 over 100 times, over 200 times, over 300 times, over 400 times, over 500 times, over 700 times, over 1,000 times, over 2,000 times, over 3,000 times, over 4,000 times or over 5,000 times. In a preferred embodiment of the present invention, the number of times that method returns from sub-step 544 to sub-step 532 is at least partially based on at least one of a computational time available, computational resources available, and a convergence time of optimization problem being solved by the evolutionary algorithm of the method.

If at sub-step 544, a decision is made not to breed additional candidate SOPs 534, the method proceeds to sub-step 548, at which the method selects at least one partially-optimal SOP 554 from candidate SOPs 534. Preferably one or more partially-optimal SOPs 554 are selected from that multiplicity of desirable candidate SOPs identified from candidate SOPs 534 which was generated during a final iteration of sub-step 542, i.e., the iteration of sub-step 542 which was run immediately preceding that iteration of sub-step 544 which was run immediately preceding sub-step 548.

As discussed hereinabove, human operators are often hesitant to make large changes in current operating setups based on suggestions from artificial intelligence programs, particularly for large-scale, expensive, and often potentially dangerous, industrial processes. Therefore, the present invention preferably returns partially-optimal SOPs, which preferably require relatively small adjustments to the SOPs of the industrial process. As described in more detail hereinbelow, in the embodiment of the present invention described with reference to FIG. 3A, by implementing the one or more partially-optimal SOPs, an operator can change operating parameters of the industrial process gradually, by narrowing OPVR spreads gradually from relatively broad historical multiple-SOP OPVR spreads 462 to increasingly narrow partially-optimal OPVR spreads, until reaching relatively most narrow optimal OPVR spreads. This is in contrast to changing values or value ranges of OPVRs relatively drastically, as would result from implementing an optimal SOP immediately, without an intermediate implementation of any of the one or more partially-optimal SOPs.

It is appreciated that in the method of FIG. 3A, partially-optimal SOPs 554 are preferably identified by applying at least one EA to operational data 412.

Preferably, OPVR spreads are narrowed each successive time the EA shown particularly in FIG. 3F is run. More particularly, the EA includes parameters which constrain the requirements for a relative improvement of sets of KPIs associated with partially-optimal SOPs or optimal SOPs with respect to historical sets of KPIs. Preferably, these parameters are changed each successive time the EA shown particularly in FIG. 3F is run, thereby preferably resulting in partially-optimal SOPs or optimal SOPs having higher KPIs each successive time the EA shown particularly in FIG. 3F is run. Preferably, together with successively tightening requirements regarding improvement in the KPIs, the EA also loosens the thresholding functionality of the cost function, as described hereinabove.

As seen particularly in Table D1 of FIG. 3B, partially-optimal SOP 554 preferably includes types of operating parameters 418 and a plurality of partially-optimal OPVRs 556, each of partially-optimal OPVRs 556 corresponding to one of types of operating parameters 418. Similar to historical OPVRs 420 and candidate OPVRs 536, each of partially-optimal OPVRs 556 typically has a minimum partially-optimal parameter value and a maximum partially-optimal parameter value. A difference between the minimum partially-optimal parameter value and the maximum partially-optimal parameter value defines a partially-optimal OPVR spread. Thus, the minimum partially-optimal parameter value and the maximum partially-optimal parameter value are separated by the partially-optimal OPVR spread.

In a preferred embodiment of the present invention, each of partially-optimal OPVRs 556 lies entirely within a corresponding one of the historical multiple-SOP OPVRs. In other words, preferably, the minimum partially-optimal parameter value is greater than or equal to historical multiple-SOP minimum parameter value 464, and the maximum partially-optimal parameter value is less than or equal to historical multiple-SOP maximum parameter value 466 for the historical multiple-SOP OPVR corresponding to that type of operating parameter 418 to which the partially-optimal OPVR 556 corresponds.

Additionally, each partially-optimal SOP 554 is preferably associated with a partially-optimal set of KPIs 562. Each partially-optimal set of KPIs 562 typically includes plurality of types of KPIs 422 and a plurality of partially-optimal KPI values 564, which together quantify a desirability of the partially-optimal SOP 554 with which the partially-optimal set of KPIs 562 is associated. As seen particularly in Table D2 of FIG. 3B, each of partially-optimal KPI values 564 corresponds to one of the types of KPIs 422. It is appreciated that partially-optimal sets of KPIs 562 are typically projected KPIs, and partially-optimal KPI values 564 are typically estimated by the method of FIG. 3A.

Turning once more to FIGS. 3B & 3F, at an optional next sub-step 570, the method preferably provides a set of KPI weighting ranges 572 for which partially-optimal SOP 554 is particularly suitable. As discussed hereinabove with reference to FIG. 3A, KPI weighting coefficients 428 are preferably provided at step 410 for types of KPIs 422. KPI weighting coefficients 428 offer a numeric indication of relative importance of various ones of types of KPIs 422. Also, as described hereinabove, the KPI weighting coefficients 428 provided at step 410 are subject to change based on various circumstances and considerations.

Since partially-optimal SOP 554 is selected at least partially based on the KPI weighting coefficients 428 provided at step 410, a change in the KPI weighting coefficients 428 may result in a change in which candidate SOP 534 is identified as a partially-optimal SOP 554. However, not every change in the KPI weighting coefficients 428 necessarily results in a change in which candidate SOP 534 is identified as a partially-optimal SOP 554.

Therefore, if a user is aware of a change in the KPI weighting coefficients 428, the user may choose to run the method again, in order to either confirm that a previously identified partially-optimal SOP 554 is still partially-optimal for the updated KPI weighting coefficients 428, or to identify an updated partially-optimal SOP 554 based on the updated KPI weighting coefficients 428.

In order to save time, and reduce a number of times which the method is run, the method preferably provides KPI weighting ranges 572 at sub-step 570. KPI weighting ranges 572 indicate ranges of KPI weighting coefficients 428 for which the partially-optimal SOP 554 identified at sub-step 548 is particularly suitable. Thus, if the industrial process is subject to change in the KPI weighting coefficients 428 after step 410, the updated KPI coefficients may be compared to KPI weighting ranges 572 provided at sub-step 570 in order to check whether or not partially-optimal SOP 554 identified at sub-step 548 is still optimal for the updated KPI weighting coefficients 428.

For example, if the YIELD type of KPI 122 were assigned a KPI weighting coefficient 428 of 55% at step 410, and later the KPI weighting coefficient 428 associated with the YIELD type of KPI 422 was changed to 50%, a user can preferably consult KPI weighting ranges 572 provided at sub-step 570 and confirm that the KPI weighting coefficient 428 associated with the YIELD type of KPI 422 is still within the KPI weighting range 572 for the YIELD type of KPI 422 of 50-60%, and therefore, assuming that all other KPI weighting coefficients 428 are also still within the KPI weighting ranges 572 of corresponding types of KPIs 422, there is no need to run the method of FIG. 3A again to find a new partially-optimal SOP 554.

Additionally, as seen particularly in Table D3 of FIG. 3B, in a preferred embodiment of the present invention, at sub-step 548, at least one additional partially-optimal SOP 554 is selected from candidate SOPs 534. Preferably, each additional partially-optimal SOP 554 is associated with a corresponding additional partially-optimal set of KPIs 562. For each of additional partially-optimal SOPs 554 there is preferably provided an associated, preferably unique, additional set of KPI weighting ranges 572, which are preferably provided at sub-step 570. Additional sets of KPI weighting ranges 572 indicate for which values of KPI weighting coefficients 428 respective additional partially-optimal SOPs 554 are particularly suitable. Thus, if the industrial process is subject to change in the KPI weighting coefficients 428 after step 410, the updated KPI coefficients 428 may be compared to all KPI weighting ranges 572 provided at sub-step 570 in order to check which of partially-optimal SOPs 554 identified at sub-step 548 is most suitable for the updated KPI weighting coefficients 428.

For example, if the YIELD type of KPI 422 were assigned a KPI weighting coefficient 428 of 55% at step 410, and later the KPI weighting coefficient 428 associated with the YIELD type of KPI 422 was changed to 63%, and the KPI weighting range 572 for the YIELD type of KPI 422 is 45-60% for partially-optimal SOP 554, a user can preferably consult additional KPI weighting ranges 572 of additional partially-optimal SOPs 254 provided at sub-step 570, and identify an additional partially-optimal SOP 554 having a KPI weighting range 572 for the YIELD type of KPI 422 including 63%, as well as KPI weighting ranges 572 including all other KPI weighting coefficients 428 corresponding types of KPIs 422. The user can preferably select that additional partially-optimal SOP 554 as the desirable partially-optimal SOP 554 to implement in the industrial process, with no need to run the method of FIG. 3A again in order to find a new partially-optimal SOP 254.

Turning once more to FIG. 3A, and as seen particularly in Table D1 of FIG. 3B, at an optional next step 582, an optimal partially-optimal operating parameter value 586 is preferably provided for at least one partially-optimal OPVR 556. More preferably, an optimal partially-optimal operating parameter value 586 is preferably provided for each of partially-optimal OPVRs 556. Optimal partially-optimal operating parameter value 586 is preferably a particularly desirable value within partially-optimal OPVR 556 for that type of operating parameter 418. In other words, if the industrial process were to attempt to maintain a particular value within partially-optimal OPVR 556, the method recommends attempting to maintain the value of optimal partially-optimal operating parameter value 586.

In one embodiment of the present invention, optimal partially-optimal operating parameter value 586 is a parameter value that is associated with a particularly desirable partially-optimal set of KPIs 562. In another embodiment of the present invention, optimal partially-optimal operating parameter value 586 is a parameter value that occurs particularly often in operational data 412, indicating that optimal partially-optimal operating parameter value 586 is particularly easy to achieve and maintain in the industrial process.

At a next step 590, at least one partially-optimal SOPs 554, of the one or more partially-optimal SOPs 554 generated at step 528, is preferably implemented in the industrial process. It is appreciated that as used herein, “implementing” a particular SOP is used to mean changing an SOP of the industrial process to match the particular SOP that is being implemented, and preferably to run the industrial process or a sub-process of the industrial process using the particular SOP one or more times.

In one embodiment of the present invention, the implementation of the at least one partially-optimal SOP 554 is a manual implementation. In another embodiment of the present invention, the implementation of the at least one partially-optimal SOP 554 is an automated implementation. In yet another embodiment of the present invention, the implementation of the at least one partially-optimal SOP 554 is a partially manual and partially automated implementation.

Preferably, in a case wherein at least one optimal partially-optimal operating parameter value 586 is provided for at least one of partially-optimal OPVRs 556 at step 582, optimal partially-optimal operating parameter value 586 is employed in implementing partially-optimal OPVRs 556 of the at least one partially-optimal SOP 554 at step 590. For example, for a type of operating parameter 418 that represents a machine setpoint, the machine setpoint is preferably set to optimal partially-optimal operating parameter value 586.

At a next step 591, a decision is made whether or not to provide any additional partially-optimal OPVRs 556. If any additional partially-optimal OPVRs 556 are to be provided, for example if previously provided partially-optimal OPVRs 554 have an undesirably large partially-optimal OPVR spreads, the method returns to step 528, at which at least one additional partially-optimal SOP 554 is provided, the additional partially-optimal SOP 554 having at least one partially-optimal OPVRs 556 that has a partially-optimal OPVR spread that is narrower than a corresponding partially-optimal OPVR spread provided during a previous execution of step 528.

If no additional partially-optimal OPVRs 556 are to be provided, the method proceeds to a next step 592, at which at least one optimal SOP 594 is provided. As seen particularly in Table E1 of FIG. 3B, each of optimal SOPs 594 preferably includes plurality of types of operating parameters 418 and a plurality of optimal OPVRs 596, each of optimal OPVRs 596 corresponding to one of types of operating parameters 418. Similar to partially-optimal OPVRs 556, each of optimal OPVRs 596 typically has a minimum optimal parameter value and a maximum optimal parameter value. A difference between the minimum optimal parameter value and the maximum optimal parameter value defines an optimal OPVR spread. Thus, the minimum optimal parameter value and the maximum optimal parameter value are separated by the optimal OPVR spread.

It is appreciated that as used herein, “optimal” is used to mean particularly desirable and preferably a best. Thus, an optimal SOP is an SOP which is associated with a particularly desirable optimal set of KPIs, as at least partially determined by the KPI weighting coefficients 428 provided at step 410. It is appreciated that in the method of FIG. 3A, optimal SOPs 594 are preferably identified by applying at least one EA to operational data 412.

In a preferred embodiment of the present invention, each of partially-optimal OPVRs 556 lies entirely within a corresponding one of the historical multiple-SOP OPVRs. In other words, preferably, the minimum partially-optimal parameter value is greater than or equal to historical multiple-SOP minimum parameter value 464, and the maximum partially-optimal parameter value is less than or equal to historical multiple-SOP maximum parameter value 466 for the historical multiple-SOP OPVR corresponding to that type of operating parameter 418 to which the partially-optimal OPVRs 556 corresponds. Thus, each of the partially-optimal OPVR spreads is preferably smaller than a corresponding one of historical multiple-SOP OPVR spreads 462.

Additionally, each of partially-optimal OPVRs 556 preferably at least partially overlap a corresponding one of optimal OPVRs 596. In other words, preferably, the minimum partially-optimal parameter value is less than or equal to the minimum optimal historical value, and/or the maximum partially-optimal parameter value is greater than or equal to the maximum optimal parameter value for the partially-optimal OPVR 556 corresponding to that type of operating parameter 418 to which the optimal OPVR 596 corresponds. Thus, each of the partially-optimal OPVR spreads is preferably larger than a corresponding one of the optimal OPVR spreads.

Additionally, each optimal SOP 594 is preferably associated with an optimal set of KPIs 602. Each optimal set of KPIs 602 typically includes plurality of types of KPIs 422 and a plurality of optimal KPI values 604, which together quantify a desirability of the optimal SOP 594 with which the optimal set of KPIs 602 is associated. As seen particularly in Table E2 of FIG. 3B, each of optimal KPI values 604 corresponds to one of the types of KPIs 422. It is appreciated that optimal sets of KPIs 602 are typically projected KPIs, and optimal KPI values 604 are typically estimated by the method of FIG. 3A.

As seen in FIG. 3F, optimal SOPs 594 are preferably generated by the EA of step 592, in substantially identical sub-steps to the sub-steps of step 528. As described hereinabove, a main difference between the EA of step 592 and the EA of step 528 is how tightly parameters, particularly relating to one or both of a relative improvement of sets of KPIs associated with partially-optimal SOPs or optimal SOPs with respect to historical sets of KPIs and the thresholding functionality of the cost function, are constrained during respective iterations of the EA.

Turning once more to FIGS. 3B & 3F, at optional sub-step 570, the method preferably provides a set of KPI weighting ranges 608 for which optimal SOP 594 is particularly suitable. As discussed hereinabove with reference to FIG. 3A, KPI weighting coefficients 428 are provided at step 410 for types of KPIs 422. The KPI weighting coefficients 428 offer a numeric indication of relative importance of various ones of types of KPIs 422. Also, as described hereinabove, the KPI weighting coefficients 428 provided at step 410 are subject to change based on various circumstances and considerations.

Since optimal SOP 594 is selected at least partially based on the KPI weighting coefficients 428 provided at step 410, a change in the KPI weighting coefficients 428 may result in a change in which candidate SOP 534 is identified as an optimal SOP 594. However, not every change in the KPI weighting coefficients 428 necessarily results in a change in which candidate SOP 534 is identified as an optimal SOP 594.

Therefore, if a user is aware of a change in the KPI weighting coefficients 428, the user may choose to run the method again, in order to either confirm that a previously identified optimal SOP 594 is still optimal for the updated KPI weighting coefficients 428, or to identify an updated optimal SOP 594 based on the updated KPI weighting coefficients 428.

In order to save time, and reduce a number of times which the method is run, the method preferably provides KPI weighting ranges 608 at sub-step 570. KPI weighting ranges 608 indicate ranges of KPI weighting coefficients 428 for which the optimal SOP 594 identified at sub-step 548 is particularly suitable. Thus, if the industrial process is subject to change in the KPI weighting coefficients 428 after step 410, the updated KPI coefficients 428 may be compared to KPI weighting ranges 608 provided at sub-step 570 in order to check whether or not optimal SOP 594 identified at sub-step 548 is still optimal for the updated KPI weighting coefficients 428.

For example, if the YIELD type of KPI 422 were assigned a KPI weighting coefficient 428 of 55% at step 410, and later the KPI weighting coefficient 428 associated with the YIELD type of KPI 422 was changed to 50%, a user can preferably consult KPI weighting ranges 608 provided at sub-step 570 and confirm that the KPI weighting coefficient 428 associated with the YIELD type of KPI 422 is still within the KPI weighting range 608 for the YIELD type of KPI 422 of 50-60%, and therefore, assuming that all other KPI weighting coefficients 428 are also still within the KPI weighting ranges 608 of corresponding types of KPIs 422, there is no need to run the method of FIG. 3A again to find a new optimal SOP 594.

Additionally, as seen particularly in Table E3 of FIG. 3B, in a preferred embodiment of the present invention, at sub-step 548, at least one additional optimal SOP 594 is selected from candidate SOPs 534. Preferably, each additional optimal SOP 594 is associated with a corresponding additional optimal set of KPIs 602. For each of additional optimal SOPs 594 there is preferably provided an associated, preferably unique, additional set of KPI weighting ranges 608, which are preferably provided at sub-step 570. Additional sets of KPI weighting ranges 608 indicate for which values of KPI weighting coefficients 428 respective additional optimal SOPs 594 are particularly suitable. Thus, if the industrial process is subject to change in the KPI weighting coefficients 428 after step 410, the updated KPI coefficients 428 may be compared to all KPI weighting ranges 608 provided at sub-step 570 in order to check which of optimal SOPs 594 identified at sub-step 548 is most suitable for the updated KPI weighting coefficients 428.

For example, if the YIELD type of KPI 422 were assigned a KPI weighting coefficient 428 of 55% at step 410, and later the KPI weighting coefficient 428 associated with the YIELD type of KPI 422 was changed to 63%, and the KPI weighting range 608 for the YIELD type of KPI 422 is 50-60% for optimal SOP 594, a user can preferably consult additional KPI weighting ranges 608 of additional optimal SOPs 594 provided at sub-step 570, and identify an additional optimal SOP 594 having a KPI weighting range 608 for the YIELD type of KPI 422 including 63%, as well as KPI weighting ranges 608 including all other KPI weighting coefficients 428 corresponding types of KPIs 422. The user can preferably select that additional optimal SOP 594 as the desirable optimal SOP 594 to implement in the industrial process, with no need to run the method of FIG. 3A again in order to find a new optimal SOP 594.

As seen particularly in FIG. 3A and Table E1 of FIG. 3B, at an optional next step 612, an optimal operating parameter value 616 is provided for at least one of optimal OPVRs 596. More preferably, an optimal operating parameter value 616 is preferably provided for each of optimal OPVRs 596. Optimal operating parameter value 616 is preferably a particularly desirable value within optimal OPVR 596 for that type of operating parameter 418. In other words, if the industrial process were to attempt to maintain a particular value within optimal OPVR 596, the method recommends attempting to maintain the value of optimal operating parameter value 616.

In one embodiment of the present invention, optimal operating parameter value 616 is a parameter value that is associated with a particularly desirable set of KPIs 602. In another embodiment of the present invention, optimal operating parameter value 616 is a parameter value that occurs particularly often in operational data 412, indicating that optimal operating parameter value 616 is particularly easy to achieve and maintain in the industrial process.

The method then proceeds to an optional next step 630, at which optimal OPVRs 296 of at least one of optimal SOPs 594 selected at step 592 is preferably implemented in the industrial process. It is appreciated that as used herein, “implementing” a particular SOP is used to mean changing an SOP of the industrial process to match the particular SOP that is being implemented, and preferably to run the industrial process or a sub-process of the industrial process using the particular SOP one or more times.

In one embodiment of the present invention, the implementation of optimal SOP 594 is a manual implementation. In another embodiment of the present invention, the implementation of optimal SOP 594 is an automated implementation. In yet another embodiment of the present invention, the implementation of optimal SOP 594 is a partially manual and partially automated implementation.

Preferably, in a case wherein at least one optimal operating parameter value 616 is provided for at least one of optimal OPVRs 596 at step 612, optimal operating parameter value 616 is employed in implementing optimal OPVRs 596 of optimal SOP 594 at step 630. For example, for a type of operating parameter 418 that represents a machine setpoint, the machine setpoint is preferably set to optimal operating parameter value 616.

Preferably, in an embodiment in which KPI weighting ranges 608 are provided at sub-step 570, before implementing optimal OPVRs 596 of optimal SOP 594 at step 630, the method ascertains that the set of KPI weighting ranges 608 associated with optimal SOP 594 is desirable for the industrial process.

For example, consider a case wherein KPI weighting coefficients 428 have changed from the KPI weighting coefficients 428 provided at step 410, and the updated KPI weighting coefficients 428 do not fall within the KPI weighting ranges 608 for the optimal SOP 594 provided at sub-step 548 of step 592. In that case, the optimal SOP 594 implemented in the industrial process at step 630 is preferably an additional optimal SOP 594 provided sub-step 548 of step 592, the additional optimal SOP 594 being associated with an additional set of KPI weighting ranges 608, provided at sub-step 570, where the updated KPI weighting coefficients 428 fall within the additional KPI weighting ranges 608.

Preferably, in addition to or in lieu of implementing the at least one partially-optimal SOPs 554 at step 590 and optimal SOPs 594 at step 630, the method additionally or alternatively identifies and displays partially-optimal SOPs 554 and/or optimal SOPs 594 to a user, for example by providing a digital readout or printed readout of partially-optimal SOPs 554 and/or optimal SOPs 594.

It is appreciated that the method of FIG. 3A may be run any suitable number of times, for example, upon collection of additional operational data suitable to be provided at step 410.

Reference is now made to FIG. 4, which is a simplified schematic illustration of a system 650 for implementing an optimal set of operating parameters (SOP) in an industrial process, which involves operation of at least one machine 652, useful in performing the methods of FIG. 3A.

As seen in FIG. 4, system 650 preferably forms part an industrial process involving an operation of at least one machine 652, including either a single machine 652, such as a motor or transformer, or multiple machines 652, such as a mining process or a manufacturing process.

At least one of machines 652 preferably includes at least one sensor 654. Additionally, at least one of machines 652 preferably includes at least one actuator or controller 656. In one embodiment of the present invention, at least one of machines 652 includes both of at least one sensor 654 and at least one actuator or controller 656.

In a preferred embodiment of the present invention, system 650 includes an Operational Data Database and Selector (ODDS) 662 which preferably receives and provides at least one set of operational data, such as operational data 412, including a plurality of historical SOPs and a plurality of historical sets of KPIs, such as historical SOPs 414 and historical sets of KPIs 416.

ODDS 662 preferably receives at least some of the historical SOPs from some of sensors 654. Additionally, ODDS 662 preferably receives at least some of the historical sets of KPIs from some of sensors 654. Additionally or alternatively, some of the data supplied to ODDS 662 are provided by records of actionable values set by users (e.g., a target oven temperature set by an operator). ODDS 662 preferably performs step 410 of the method of FIG. 3A.

Preferably, in addition to receiving and storing historical operating data, ODDS 662 is also operative to select a sub-set of the operating data, particularly a sub-set of the historical SOPs, to form at least part of an initial population of SOPs. As described hereinabove with reference to sub-step 530 of the method of FIG. 3A, the initial population may be a random initial population or a non-random initial population.

Preferably, system 650 preferably optionally includes an SOP generator 668 which preferably receives the operational data from ODDS 662 and employs the operational data to generate at least one additional SOP, such as the at least one additional SOP generated at step 510 of the method of FIG. 3A.

Preferably, system 650 preferably additionally includes an optional first evolutionary algorithm (EA) engine 682, which preferably receives operational data from ODDS 662 and, optionally, the additional SOP or SOPs from SOP generator 668. First EA engine 682 preferably applies an EA to the operational data, and, optionally, the additional SOP as well, thereby identifying at least one partially-optimal SOP, such as partially-optimal SOP 554, including types of operating parameters, such as types of operating parameters 418, and optimal operating parameter value ranges (OPVRs), such as partially-optimal OPVRs 556. First EA engine 682 preferably performs step 528 of the method of FIG. 3A.

In a preferred embodiment of the present invention, system 650 further includes an optional value-selecting engine 684 for providing at least one optimal operating parameter value, such as optimal partially-optimal operating parameter value 586 for at least one of the optimal OPVRs, as described with reference to step 582 of the method of FIG. 3A. Value-selecting engine 684 preferably generates the optimal partially-optimal operating parameter value or values at least partially based on the partially-optimal SOPs, received from first EA engine 682. In a preferred embodiment of the present invention, value-selecting engine 684 preferably also employs data provided by ODDS 662 to generate the optimal partially-optimal operating parameter value or values.

In a preferred embodiment of the present invention, system 650 further includes a second EA engine 686 for providing one or more optimal SOPs, such as optimal SOPs 554, as described with particular reference to step 592 of the method of FIG. 3. As described hereinabove, the optimal SOPs preferably include types of operating parameters, such as types of operating parameters 418, and optimal OPVRs, such as optimal OPVRs 596. Preferably, second EA engine 686 employs the historical SOPs, provided by ODDS 662, and, optionally, the additional SOP or SOPs from SOP generator 668, to generate the optimal SOP or SOPs. In one embodiment of the present invention, second EA engine 686 additionally employs the partially-optimal SOPs, provided by first EA engine 682, to generate the optimal SOP or SOPs. Second EA engine 686 preferably performs step 592 of the method of FIG. 3A.

Preferably, value-selecting engine 684 additionally provides at least one optimal operating parameter value, such as optimal operating parameter value 616, for the optimal OPVRs, as described with reference to step 612 of the method of FIG. 3A. Value-selecting engine 684 preferably generates the optimal operating parameter value or values at least partially based on the optimal SOPs, received from second EA engine 686. In a preferred embodiment of the present invention, value-selecting engine 684 preferably also employs data provided by ODDS 662 to generate the optimal operating parameter value or values.

Preferably, system 650 further optionally includes an SOP implementor 690 for implementing the partially-optimal SOPs, provided by first EA engine 682, and/or the optimal SOPs, provided by second EA engine 686, in the industrial process, as described in respective steps 590 and 630 of the method of FIG. 3A.

As described hereinabove, the implementation of the partially-optimal SOPs and optimal SOPs may be a manual implementation, an automated implementation, or an implementation that is partially manual and partially automated. In a preferred embodiment of the present invention, the automatic implementation of the partially-optimal SOPs and optimal SOPs is facilitated by either direct or indirect communication between SOP implementor 690 and some or all of actuators or controllers 656.

It will be appreciated by persons skilled in the art that the present invention is not limited to what has been particularly shown and described hereinabove. The scope of the present invention includes both combinations and subcombinations of various features described hereinabove as well as modifications thereof, all of which are not in the prior art.

1. A method for implementing an optimal set of operating parameters (SOP) in an industrial process, which involves operation of at least one machine, the method comprising:
providing operational data, said operational data comprising a multiplicity of historical SOPs;
generating at least one additional SOP from said operational data;
applying an evolutionary algorithm (EA) to said operational data, thereby identifying an optimal SOP, said applying comprising:
supplying to said EA a subset of said historical SOPs and said at least one additional SOP;
employing said subset of said historical SOPs and said at least one additional SOP in breeding a multiplicity of candidate SOPs; and
selecting an optimal SOP from said candidate SOPs; and
implementing said optimal SOP in said industrial process.

2. A method according to claim 1 and wherein:
said operational data further comprises a multiplicity of historical sets of Key Performance Indicators (KPIs), each of said historical sets of KPIs corresponding to one of said historical SOPs; and
each of said subset of said historical SOPs comprises one of said historical SOPs corresponding to a particularly desirable one of said historical sets of KPIs.

3. A method according to claim 1 and wherein:
said operational data further comprises a multiplicity of historical sets of Key Performance Indicators (KPIs); and
said at least one additional SOP comprises:
a plurality of types of operating parameters; and
a plurality of additional operating parameter value ranges (OPVRs), each of said plurality of additional OPVRs corresponding to a particularly desirable one of said historical sets of KPIs.

4-20. (canceled)

21. A method for implementing an optimal set of operating parameters (SOP) in an industrial process, which involves operation of at least one machine, the method comprising:
providing operational data, said operational data comprising:
a multiplicity of historical SOPs, each of said historical SOPs comprising:
a multiplicity of types of operating parameters; and
a plurality of historical single-SOP operating parameter value ranges (OPVRs), each of said historical single-SOP OPVRs corresponding to one of said types of operating parameters; and
at least one historical combined SOP, said historical combined SOP comprising:
said multiplicity of types of operating parameters; and
a plurality of historical multiple-SOP OPVRs, each of said historical multiple-SOP OPVRs corresponding the multiple ones of said historical single-SOP OPVRs;
applying at least one Evolutionary Algorithm (EA) to said operational data, thereby identifying an optimal SOP, said optimal SOP comprising:
said multiplicity of types of operating parameters; and
a plurality of optimal OPVRs, each of said optimal OPVRs corresponding to one of said types of operating parameters and lying entirely within a corresponding one of said historical multiple-SOP OPVRs;
providing at least one partially-optimal SOP, each of said at least one partially-optimal SOPs comprising:
said multiplicity of types of operating parameters; and
a plurality of partially-optimal OPVRs, each of said partially-optimal OPVRs corresponding to one of said types of operating parameters and lying entirely within a corresponding one of said historical multiple-SOP OPVRs and at least partially overlapping a corresponding one of said optimal OPVRs; and
implementing said at least one partially-optimal SOP in said industrial process.

22. A method according to claim 21 and further comprising:
providing an optimal partially-optimal operating parameter value for at least one of said partially-optimal OPVRs; and
employing said optimal partially-optimal operating parameter value in implementing said partially-optimal SOP in said industrial process.

23. A method according to claim 22 and wherein said providing said optimal partially-optimal operating parameter value for at least one of said partially-optimal OPVRs comprises providing said optimal partially-optimal operating parameter value for each of said partially-optimal OPVRs.

24. A method according to claim 21 and further comprising implementing said optimal SOP in said industrial process.

25. A method according to claim 21 and wherein said partially-optimal OPVRs comprise:
a first sub-set of partially-optimal OPVRs, corresponding to a first sub-set of said multiplicity of types of operating parameters, said first sub-set of partially-optimal OPVRs being substantially identical with a corresponding sub-set of said optimal OPVRs; and
a second sub-set of partially-optimal OPVRs, corresponding to a second sub-set of said multiplicity of types of operating parameters, said second sub-set of partially-optimal OPVRs being substantially identical with a corresponding sub-set of said historical multiple-SOP OPVRs.

26. A method according to claim 21 and wherein:
each of said historical multiple-SOP OPVRs has a historical multiple-SOP minimum parameter value and a historical multiple-SOP maximum parameter value, which are separated by a historical multiple-SOP OPVR spread;
each of said optimal OPVRs has a minimum optimal parameter value and a maximum optimal parameter value, which are separated by an optimal OPVR spread; and
each of said partially-optimal OPVRs has a minimum partially-optimal parameter value and a maximum partially-optimal parameter value, which are separated by a partially-optimal OPVR spread, said partially-optimal OPVR spread being smaller than a corresponding one of said historical multiple-SOP OPVR spreads and larger than a corresponding one of said optimal OPVR spreads.

27. A method according to claim 21 and wherein said at least one partially-optimal SOP is identified by applying a non-evolutionary algorithm to said optimal SOP.

28. A method according to claim 21 and wherein said at least one partially-optimal SOP is identified by applying at least one EA to said operational data.

29-47. (canceled)

48. A system for implementing an optimal set of operating parameters (SOP) in an industrial process, which involves operation of at least one machine, the system comprising:
an operational data database and selector for providing operational data, said operational data comprising:
a multiplicity of historical SOPs, each of said historical SOPs comprising:
a multiplicity of types of operating parameters; and
a plurality of historical single-SOP operating parameter value ranges (OPVRs), each of said historical single-SOP OPVRs corresponding to one of said types of operating parameters; and
at least one historical combined SOP, said historical combined SOP comprising:
said multiplicity of types of operating parameters; and
a plurality of historical multiple-SOP OPVRs, each of said historical multiple-SOP OPVRs corresponding the multiple ones of said historical single-SOP OPVRs;
an optimal evolutionary algorithm (EA) engine for applying at least one EA to said operational data, thereby identifying an optimal SOP, said optimal SOP comprising:
said multiplicity of types of operating parameters; and
a plurality of optimal OPVRs, each of said optimal OPVRs corresponding to one of said types of operating parameters and lying entirely within a corresponding one of said historical multiple-SOP OPVRs;
an additional algorithm engine for providing at least one partially-optimal SOP, each of said at least one partially-optimal SOPs comprising:
said multiplicity of types of operating parameters; and
a plurality of partially-optimal OPVRs, each of said partially-optimal OPVRs corresponding to one of said types of operating parameters and lying entirely within a corresponding one of said historical multiple-SOP OPVRs and at least partially overlapping a corresponding one of said optimal OPVRs; and
an SOP implementor for implementing said at least one partially-optimal SOP in said industrial process.

49. A system according to claim 48 and further comprising:
a value-selecting engine for providing an optimal partially-optimal operating parameter value for at least one of said partially-optimal OPVRs; and wherein said SOP implementor employs said optimal partially-optimal operating parameter value in implementing said partially-optimal SOP in said industrial process.

50. A system according to claim 49 and wherein said providing said optimal partially-optimal operating parameter value for at least one of said partially-optimal OPVRs comprises providing said optimal partially-optimal operating parameter value for each of said partially-optimal OPVRs.

51. A system according to claim 48 and wherein said partially-optimal OPVRs comprise:
a first sub-set of partially-optimal OPVRs, corresponding to a first sub-set of said multiplicity of types of operating parameters, said first sub-set of partially-optimal OPVRs being substantially identical with a corresponding sub-set of said optimal OPVRs; and
a second sub-set of partially-optimal OPVRs, corresponding to a second sub-set of said multiplicity of types of operating parameters, said second sub-set of partially-optimal OPVRs being substantially identical with a corresponding sub-set of said historical multiple-SOP OPVRs.

52. A system according to claim 48 and wherein:
each of said historical multiple-SOP OPVRs has a historical multiple-SOP minimum parameter value and a historical multiple-SOP maximum parameter value, which are separated by a historical multiple-SOP OPVR spread;
each of said optimal OPVRs has a minimum optimal parameter value and a maximum optimal parameter value, which are separated by an optimal OPVR spread; and
each of said partially-optimal OPVRs has a minimum partially-optimal parameter value and a maximum partially-optimal parameter value, which are separated by a partially-optimal OPVR spread, said partially-optimal OPVR spread being smaller than a corresponding one of said historical multiple-SOP OPVR spreads and larger than a corresponding one of said optimal OPVR spreads.

53. A system according to claim 48 and wherein said additional algorithm engine is an additional non-EA engine for applying a non-evolutionary algorithm to said optimal SOP.

54. A system according to claim 48 and wherein said additional algorithm engine is an additional EA engine for applying at least one EA to said operational data.

55. A method according to claim 1, wherein said selecting said optimal SOP from said candidate SOPs comprises applying a cost function to the candidate SOPs.

56. A method according to claim 55, wherein said cost function comprises a Mann-Whitney Stochastic order analysis.
